(19) United States
(12) Patent Application Publication
(10) Pub. No.: US 2016/0135657 A1
(43) Pub. Date: May 19, 2016

(54) Disposable Porous Cleaning Devices and Methods

(71) Applicant: Porex Corporation, Fairburn, GA (US)

(72) Inventors: Guoqiang Mao, Peachtree City, GA (US); Michael Arthur, Douglasville, GA (US); Jerry Dean Raney, Smyrna, GA (US)

(21) Appl. No.: 14/885,390

(22) Filed: Oct. 16, 2015

Related U.S. Application Data
(60) Provisional application No. 62/065,297, filed on Oct. 17, 2014.
(60) Provisional application No. 62/096,625, filed on Dec. 24, 2014.
(60) Provisional application No. 62/096,632, filed on Dec. 24, 2014.

(51) Int. Cl. A47L 13/16; A61C 17/00; A47L 13/17; A45D 34/04; A61C 19/06; A45D 29/17; A61C 15/02; A45D 29/11

(52) U.S. Cl. CPC A47L 13/16; A61C 15/02; A61C 17/00; A45D 29/11; A45D 34/04; A61C 19/066; A45D 29/17; A47L 13/17

(57) ABSTRACT

Embodiments of the present disclosure relate generally to porous devices that are useful for various cleaning purposes or other uses. The devices may be formed with, impregnated with, pre-wetted with, or otherwise associated with one or more agents, such as a dental treatment agent, a nail treatment agent, a disinfectant, a lubricant, or any other cleaning agent. The devices may find particular use for cleaning somewhat delicate areas, such as gum tissues, nail cuticle beds, electronic devices, or any other uses that benefit from a self-supporting structure that can withstand pressure but that also benefit from a resilient treatment surface.

### CROSS REFERENCE TO RELATED APPLICATIONS

This application claims the benefit of U.S. Provisional Application Ser. No. 62/065,297, filed Oct. 17, 2014, titled “Porous Dental Care Devices and Use of the Same,” U.S. Provisional Application Ser. No. 62/096,625 filed Dec. 24, 2014, titled “Disposable Porous Oral Cleaning Device and Method of Using the Same,” and U.S. Provisional Application Ser. No. 62/096,632 filed Dec. 24, 2014, titled “Disposable Porous Nail treatment device and Method of Using the Same,” the entire contents of each of which are hereby incorporated by reference.

### FIELD OF THE DISCLOSURE

Embodiments of the present disclosure relate generally to porous devices that are useful for various cleaning purposes or other uses. The devices may be formed with, impregnated with, pre-wetted with, or otherwise associated with one or more agents, such as a dental treatment agent, a nail treatment agent, a disinfectant, a lubricant, or any other agent. The devices may find particular use in cleaning somewhat delicate areas, such as gum tissues, nail cuticle beds, electronic devices, or any other uses that benefit from a self-supporting structure that can withstand pressure but that also benefit from a resilient treatment surface.

### BACKGROUND

Daily life provides the opportunity for cleaning needs for many surfaces. Examples include teeth cleaning, nail cleaning, computer keyboard cleaning, personal electronic device cleaning, weaponry cleaning, medical device cleaning, and many others. Particular cleaning needs are experienced in small areas that have crevices or other areas that are not easily accessed with simply a paper towel and spray solution. Particular cleaning needs are also experienced with teeth and nails, which have sensitive tissues that are desirably not damaged during the cleaning process.

For example, good oral hygiene generally requires a suitable environment and tools. Traditional oral hygiene procedures, such as brushing teeth, require availability of cleaning tools (such as a toothbrush, dentifrice, mouthwash), clean water and a disposal facility, such as a sink. These requirements are not always available or are difficult to find when an individual is away from home (such as in a restaurant, traveling, or otherwise).

Additionally, wood toothpicks are not always optimal. Dry wood is too hard for sensitive surfaces in the mouth, such as the gums and tongue. Although wood is porous, the porosity (void space) in the wood is too low to be an effective carrier of oral cleaning agents. Wood is also not very stable when saturated with a liquid solution for extended periods and loses strength. Toothpicks are also only used to remove relatively large pieces of food lodged between the teeth. Toothpicks are inadequate to provide good mechanical brushing of the tooth surface. Current toothpicks are too stiff and poorly shaped for gums and may puncture or scratch gums.

Current commercial products, such as wood toothpicks, STIM-U-DENT (Johnson & Johnson, NJ, US) and GUM Soft Picks (Sunstar Americas Inc. Chicago, Ill., US) do not meet the need for both picking the food and plaque removal. None of them provides a soft feel and enough frictional action for removing plaque. Traditional paper or non-woven fiber cannot provide strong enough mechanical strength for picking small gaps between the teeth.

Conventional toothbrushes are not always efficient at accessing spaces between teeth. The spaces between the teeth and around the tooth/gum interface are the most critical areas for tooth and gum diseases. The mechanical action of chewing does not effectively clean these areas. These areas need flossing. However, flossing and good oral hygiene are not available to everyone, especially young children.

U.S. Pat. No. 5,133,971 describes a dry porous membrane impregnated with an oral cleaning agent packed in a pouch for oral cleaning without the need for water. The membrane requires use of a stiff member, a finger or tongue to wipe the surface of teeth.

U.S. Pat. No. 3,646,628 describes a tooth scrubber with a piece of porous foam on a plastic round stick. US2005/0210615 describes a method of using a fabric or towelette impregnated with an oral care agent to apply the oral care agent to the oral surface by wiping. U.S. Pat. No. 5,944,519 describes an oral cleaning device having a resilient foam pad and a handle. U.S. Pat. No. 7,273,327 describes an oral care device comprising a tissue cleaner and releasable material and a handle.

None of these prior art approaches provides a satisfactory solution for the market. They either require a separate handle to provide support for the soft porous foam, membrane or fabric material, or they require that a person use a finger to reach surfaces in the oral cavity. A handle increases the cost of the product. Use of a finger is not a hygienic approach, introduces bacteria, and is generally not acceptable in public. The prior art porous materials are too soft to be self-supporting. They are also inconvenient, costly, uncomfortable, and ineffective in providing oral cleaning without toothpaste or water.

Another area that is easy to get dirty but that can be hard to clean on the human body is underneath the nails. To clean underneath nails, people generally use a thin piece of metal, wood, or plastic to scrape the dirt off the nail or from underneath the nail. However, these solid non-porous materials do not always provide effective cleaning. Additionally, a solid piece of metal, wood or plastic may be too hard for cleaning the hyponychium and may cause damage. Sometimes, it is necessary to use a brush and a soap solution to brush oil or dirt from underneath nails and hyponychium. However, this process may not be available in certain locations and/or may be too tedious.

Wood sticks and devices have long been used for cleaning nails. However, dry wood may be too hard for sensitive, soft tissues around the nail, especially for the hyponychium. Although wood is porous, the porosity (void space) in the wood is often too low for it to be an effective nail cleaning agent carrier. Wood is also not very stable and may lose its strength when saturated with water or other liquid solutions for a long time.

U.S. Pat. No. 8,337,913 B1 describes a cleaning swab for cleaning, disinfecting and sealing underneath the nail. The swab has an elongated body and an absorbent component. The absorbent component is impregnated with solution. However, most foam based absorbent media are too soft to be a good scraping media for underneath the nail and hyponychium.

US 2007/0113864 describes a simple disposable manicure and nail cleaning device for removing excess paint without smearing or fouling the nail coating. The device is made from cotton at both ends and a supporting base. Even this type of device may provide a desired cleaning effect on flat surfaces, but it is too bulky to clean underneath the nail and hyponychium areas and costly to secure an absorbent to an elongated body. There are market needs for a better and simple device for cleaning, disinfecting and treatment for underneath the nail and hyponychium.

Many commercial products have been used for cleaning purposes, such as soft fabric wipers, Q-Tips, and brushers. However, these cleaning devices are not convenient in some cleaning needs. Soft fabric materials are good for a flat surface, but cannot always reach locations that the human fingers could not reach. Q-tips are cheap, but they may shed fibers and they may not reach small gaps, because the cotton swab tip is bulky and loose. Fiber-based brushes may shed fibers and can often require multiple steps to manufacture. Foam-based brushers are generally weak and lack the required strength for many cleaning purposes. There are thus needs for simple, safe, effective and low cost cleaning devices.

### SUMMARY

Embodiments of the present disclosure relate generally to porous devices that are useful for various cleaning purposes. For example, the porous devices may be useful in promoting oral hygiene. They enhance the dental care market by providing a low cost tooth cleaning device that can scrape the tooth surface to remove plaque, that is strong enough to pick between the teeth to remove food and remove stains on teeth by polishing, and that is soft enough to massage and rub the gums. These porous devices may be impregnated with one or more oral or dental treatment agents, such as mouthwash, toothpaste, antibacterial agents, and/or flavorings. In other examples, the porous devices may be useful in polishing fingernails and toenails. There is a need in the nail care market for a low cost nail cleaning device/manicure and pedicure tool that can clean sensitive and hard to reach locations of the nail bed area, by scraping underneath and around the nails to remove dirt and other stains, that is strong enough to apply pressure to cuticles and other nail areas, but that is soft enough to not damage the skin of the nail bed area. The porous device may be impregnated with one or more nail treatment agents, cleaning agents, antifungal and/or disinfection agents. In other examples, the porous devices may be useful in other cleaning applications, such as applications the benefit from lint-free, loose fiber-free, particulate-free, and/or residue-free cleaning. They may be used, for example, for cleaning personal electronic devices, keyboards, weapons, household and medical devices, and other uses.

Embodiments disclosed herein provide a single piece, self-supporting porous material that may be used as a cleaning, disinfecting and treatment device.

To obtain optimal cleaning results in a number of environments (and for human use, to provide a comfortable experience), there is described a porous cleaning device with adequate mechanical strength for receiving pressure but that has good flexibility. This flexibility can help prevent from damaging the gums or the nail bed or other human tissues in use. The devices may be designed and manufactured to be a porous structure that can hold a treatment agent inside the porous matrix. The porous structure can allow the devices to hold a larger amount of liquid than wood, solid plastic, and brush type devices currently on market.

One advantage for the devices of the present invention over products described in the prior art that the device may be self-supporting. It does not require a separate support component. The entire device may be a single piece of porous media, including an optional holding/gripping section and a cleaning section.

In one example, the porous device acts and is used like a traditional toothbrush. It is a disposable, self-supporting porous oral hygiene device that can clean teeth and the oral cavity without the need for applying toothpaste or water. The devices may release oral cleaning agents into the mouth, kill the bacteria in the mouth, remove tooth plaque by scraping the tooth surface, and provide oral freshness. The dental care device may thus be impregnated with dental cleaning agents. The dental care device may be a hydrophilic porous dental care device. The dental care device may adsorb liquid and biofilm on teeth by capillary action to help remove plaque.

In another example, the porous device acts and is used like a cuticle pusher, nail polish applying brush, or nail polish removing device. It is a disposable, self-supporting porous nail treatment device that can clean the nail bed and surrounding nail tissues. The device may release nail cleaning agents during use to provide cuticle softening, nail polish removing, or other purposes. The device could be used in various locations, such as home, hospitals, nail salons, offices, workshops, hotels, and restrooms. The porous material may be pre-impregnated with a cleaning solution, disinfecting solution, or a treatment solution for use as a cleaning or disinfecting treatment device. The device may be packaged or otherwise provided for use in a single disposable usage. The porous device could be used on both humans and/or on animals for tooth and nail cleaning.

In other examples, the porous device may be used to reach hard to clean places, such as crevices of a keyboard, crevices of a gun, personal electronics, medical devices, personal hygiene uses, household use cleaning, or other locations that are hard to reach with a traditional cleaning tool. The devices may be used to deliver a cleaning, disinfecting, or lubricating solution to narrow locations. Examples for use include but are not limited to gaps between the keys in a keyboard, gaps between electronic components in a circuit board, screen edges, edges between cellphone and its protection devices/cases, small gaps in jewelry and watches, and cleaning small grout lines. In weapons, the device could be used for cleaning and applying lubricant to the barrel, bolts, hammer, trigger, loading port, ejection port, safety block, cylinder, and other parts of the gun body. The device could also be used clean and apply lubricant for precision tools such as saws, drills and other household and industrial tool and machines. For example, the device could be used as a liquid applicator. The porous device can also prevent over applying lubricant oil during cleaning of weapons or precision tools due to wicking action. Over applying oil may result in an accumulation of more dirt later, which could cause weapon or machine malfunction. The device could be used to clean grout, apply coating to the grout, clean hard to reach locations of appliances, such as range burner edges, sink edges, etc. The porous device may be used as a detailing tool for painting edges between a wall and window or door frames, and for touching up for nail holes. It may be used as a liquid applicator or as a paste applicator. The devices described may be used by military or law enforcement personnel. The device provides a disposable, self-supporting cleaning device that can reach otherwise hard to clean places. The devices may release cleaning agents to trap dirt, sanitize, or for other purposes.

In one example, there is provided a porous cleaning device, comprising: a self-supporting porous device body comprising porous fiber materials, sintered porous polymeric materials, elastomeric materials, or combinations thereof, the porous device body comprising a working end and a holding section, the working end configured to clean a desired surface and comprising a tip and a polishing surface. The porous device body may comprise the same material throughout the body. It may be porous fiber material, such as PE/PET, PET/PET biocomponent fibers, cotton fibers, or combinations thereof.

The device may be effective for removing food between teeth, scraping teeth, polishing teeth, massaging gums, or combinations thereof. The device may be effective for polishing nails, cleaning nails, scraping nails, applying one or more agents to nails, or combination thereof. The device may be effective for cleaning crevices or hard to reach places, applying a treatment agent to crevices or hard to reach places, or a combination thereof. The device may be effective for functioning as a liquid applicator. The device include or otherwise be packaged with a cleaning or treatment agent.

These is also provided a method for treating an oral cavity, comprising using the device described for rubbing an oral surface and releasing the one or more dental treatment agents from the porous device to the oral surface.

These is also provided a method for treating a nail surface, comprising using the device described for cleaning one or more nail surfaces and releasing the one or more nail treatment agents from the porous device to the nail surface.

These is also provided a method for treating a surface or applying a treatment agent, a cleaning agent, or a lubricant solution to a surface, comprising using the device described for to clean the surface by using the tip and the polishing surface for treating the surface. The device may be pre-impregnated or pre-loaded with the treatment agent, the cleaning agent, or the lubricant solution.

### BRIEF DESCRIPTION OF THE FIGURES

FIG. 1 illustrates one embodiment of a porous cleaning device according to this disclosure, having a slender rod with two ends, one of which is a working end cut at an angle to provide a sharp tip.

FIG. 2 illustrates an alternate embodiment having two working ends.

FIG. 3 illustrates one embodiment of a porous cleaning device according to this disclosure, having a slender rod with two ends, one of which is a working end cut at an angle to provide a sharp tip.

FIG. 4 illustrates an alternate embodiment having two working ends.

FIG. 5 illustrates one embodiment of a porous cleaning device according to this disclosure, having a slender rod with two working ends cut at an angle to provide a sharp tip.

FIG. 6 illustrates one embodiment of a porous cleaning device according to this disclosure, having a rectangular-like shape with one working end.

FIG. 7 illustrates a porous cleaning device having a thick rectangular profiled structure with a contoured structure on both ends.

FIGS. 8A and 8B illustrate a porous cleaning device having a textured surface. Two edges have a thickness less than the thickness of the center of the product. The edges also have greater hardness than the center of the product. In FIG. 8A, the device has at least a sharp tip along on one of its longitudinal edges for picking.

FIG. 9 illustrates a porous cleaning device having a cleaning section and a stem.

FIG. 10 illustrates a porous cleaning device having a cleaning section and a separate hand held component.

FIG. 11 illustrates a porous cleaning device used in connection with a power tool.

FIG. 12 illustrates various body shapes of a porous cleaning device.

FIG. 13 illustrates a porous cleaning device with a hollowed structure.

FIG. 14 illustrates a packaging system for a porous cleaning device.

FIG. 15 illustrates a porous cleaning device designed for cleaning weaponry.

FIG. 16 illustrates a top perspective view of the device of FIG. 15.

FIG. 17 provides a scanning electron micrograph (SEM) of the surface of a device having longitudinally oriented thermally bound fibers.

FIG. 18 provides a scanning electron micrograph (SEM) of an end of a porous fiber device having longitudinally oriented thermally bound fibers. The pores on the fibers help remove residue from the surfaces to be cleaned.

FIG. 19 provides a side view of a scanning electron micrograph (SEM) of a sintered porous elastomeric material device comprising thermally bound polymeric particles. The pores in the devices help remove residue from the surfaces to be cleaned.

FIG. 20 provides a side view of a scanning electron micrograph (SEM) of a sintered porous plastic material device having thermally bound polymeric particles. The pores in the devices may help remove residue that may be present from polishing from the surface.

### DETAILED DESCRIPTION OF THE INVENTION

Embodiments disclosed relate generally to porous devices that are useful for various cleaning purposes or other uses. There is provided a self-supporting porous device that may be fiber-based, plastic particle-based, or elastomeric particle-based. In any of these embodiments, the device may be formed with, impregnated with, pre-wetted with, or otherwise associated with one or more agents.

The porous cleaning implements may comprise sintered porous plastic materials, sintered porous elastomeric materials, fiber materials, or combinations thereof. The sintered porous plastic materials and sintered elastomeric materials comprise polymer particles. The polymer particles may have an average particle size from 1 micron to about 500 microns. These polymer particles may be bound together by a sintering process. The polymer particles may be effective for brushing, polishing, cleaning, applying solutions, or any other uses described here.

If the device is provided as a device comprising a porous fiber material, the porous fiber materials may be thermally bonded porous fiber materials. The thermally bound fibers may be spunbond, non-woven fibers or thermally bound bicomponent fibers. The sides of the porous fibrous materials may provide a brushing, polishing, cleaning, or massaging action for the uses described herein.

In one embodiment, the device may be a porous fiber device with a fiber component substantially oriented in one direction. In a specific embodiment, the fiber component may be substantially oriented in the direction along the long axis of the device.

The porous cleaning implements may be provided with a working end. The working end may be a sharp point or tip, which can function as a pick. In one example, the working end may function as a picking device somewhat like a toothpick but by providing other unexpected advantages.

The body of the porous device may be a resilient, semi-rigid and self-supporting structure. The porous devices may have a relatively rigid skin and a relatively soft internal structure. The rigid skin and working end (which in some examples, may be a sharp point) provide strong mechanical picking and/or cleaning action. The relatively soft internal structure provides good flexibility to fit the contour of the surface to be cleaned and provides effective brushing or polishing action. The soft nature of the porous devices can massage gums, cuticles, or any other surface.

In another example, the porous device may be a single-piece porous material with a relatively uniform pore size and porosity along the device body.

In one embodiment, the device may have a section for gripping with the fingers, and a cleaning section. The section for gripping with the fingers may be grooved, notched, or otherwise marked to indicate a finger grip. In one specific embodiment, the section for gripping with the fingers and the cleaning region may have the same composition and the same pore structure. The cleaning solution may be any of the solutions described herein, or any other appropriate cleaning solutions (including those currently in existence as well as those that may be formulated in the future).

The porous devices of the present invention may be hydrophilic. The hydrophilic nature may help saliva or other liquids move into and out of the porous media. This can facilitate the release of the cleaning agent from the porous device. For example, the hydrophilic nature and high pore volume of the porous devices can help to remove colored food or drink residue from the tooth surface. A hydrophilic porous device may be useful in other environments as well. For example, in the manicure or pedicure use, hydrophilicity may help absorb extraneous cuticle oils, nail polishing remover, or other liquids. A hydrophilic device may help a cleaning, disinfection, and/or treatment solution move in and out of the porous media. It may facilitate the release of a nail treatment solution from the porous nail treatment device onto the nail surface, hyponychium, cuticle and/or eponychium.

The porous device may be made by cutting from an extruded porous fiber rod, porous fiber tube, or a porous fiber with a 3-D profile. The porous device may also be made by die cutting from a formed semi-rigid porous fiber sheet. The device can also be made using a molding process.

In some of the dental examples, the porous devices may be pre-wetted or impregnated with treatment solutions or cleaning agents. For example, the porous device may include oral hygiene agents that can be released to contact the tooth surface during scraping, picking or massaging. In another example, the porous device may be pre-wetted or impregnated with one or more nail cleaning, disinfection, and/or treatment solutions. The device may be provided in a wet state or the solution may be dried, with the device capable of being rehydrated with water or another solution during a treatment or use process.

In one embodiment, the device may have a holding section and a treatment section. In one specific embodiment, holding section and treatment section may have the same composition and the same pore structure. In another embodiment, the holding section may be provided as a wrapper or a separate holding device that may be associated with the treatment section.

In one embodiment, the device has certain compressibility under squeeze or compression action of fingers. The squeeze and compression action may help release a pre-wetted or impregnated solution.

The body of the device may have a resilient, semi-rigid and self-supporting structure. “Resilient” as used herein may mean the device does not break under normal usage or without a special tool, such as a scissors or a razor blade. “Resilient” may mean that the device has a certain amount of flexibility thereto. “Semi-rigid” may mean the device body will hold its shape and will not bend or deform under normal cleaning action, but possesses certain compressibility with finger pressure. “Self-supporting” may mean that the device is strong enough without any support structure or material. The device can generally withstand the pressure of a normal pressure from a manual cleaning process. In one specific embodiment, the body of the device may be rod-shaped. In one specific embodiment, the body of the disposable porous device may have an elongated body and a working end or a sharp point.

The disposable device may have a relatively hard skin or outer surface and relatively soft internal structure. The device may be provided with a generally sharp point. The hard skin and working end/sharp point may provide strong mechanical picking action. The relatively soft internal structure may provide good flexibility to fit the surface being cleaned.

### Structure

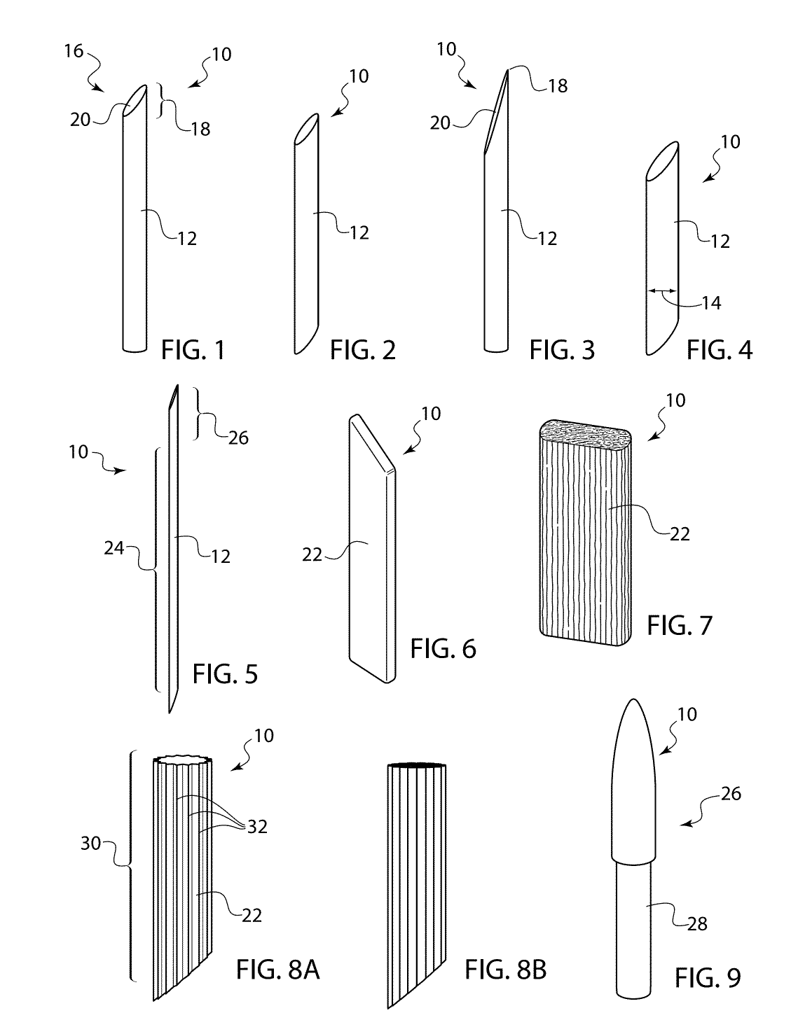

In the embodiments illustrated by FIGS. 1-9, the devices 10 disclosed may have different diameters, shapes and lengths depending on the desired application. The device's surface energy, density, cross sectional area, and surface area can be optimized for a particular need.

One example of a device 10 may be a slender rod 12. In other examples, the device 10 may be formed as having a more rectangular-like shape 22. The rectangular-like shape may be slender, as illustrated by FIG. 6, or thicker in width, as illustrated by FIG. 7.

The slender rod 12 may be particularly slender, as illustrated by FIG. 5, or it may be slightly thicker, as illustrated by FIG. 4. Any diameters are possible. In some embodiments, these device 10 may be about 1 mm to about 20 mm in diameter. The device 10 may be about 2 mm to about 10 mm in diameter. In one specific embodiment, the device 10 may be about 3 mm in diameter. It is generally desirable that the diameter 14 be such that a user may grasp the device 10 between his or her index and thumb finger, much like a pencil or an eating utensil. The device 10 may be about 20 mm to about 100 mm long. The device 10 may have one or both ends cut. FIGS. 1 and 3 illustrate embodiments of the device 10 having one end cut at an angle that provides a sharp tip. FIGS. 2, 4, and 5 illustrate other embodiments having both ends cut at an angle. The cut may be made at about a 15 to 75 degree angle with respect to the longitudinal axis of the device. The cut may be made at about a 30 to 60 degree angle. The cut may be made at about a 20 to 50 degree angle.

This angled end can help form a working end 16. The working end 16 may generally be formed as a sharp tip 18 and a polishing surface 20. The sharp tip 18 may be provided as a pointed tip or it may be made blunt, depending upon the desired use. The polishing surface 20 provides an area that may be used for many of the cleaning functions described herein.

In one embodiment, the porous cleaning device 10 has a holding section 24 and a cleaning section 26. These sections are enumerated by FIG. 5, but will generally be present on the other embodiments shown. In one specific embodiment, holding section 24 and cleaning section 26 have the same composition and the same pore structure. It is generally envisioned that the holding section 24 and the cleaning section 26 are provided as an integral unit/device.

However, it should be understood that it is possible for the holding section 24 to be provided as a separate component 38, one example of which is illustrated by FIG. 10. FIG. 10 shows an embodiment in which the holding section 24 is formed of a non-porous material, and the cleaning section 26 may be a porous cleaning section (which can essentially be a shortened version of the porous device 10). The non-porous holding section 24 could be injection molded plastic, metal, wood or any other appropriate material. The separate holding component 38 may be designed for repeat usage, and the porous cleaning section 26 may be designed for single disposable usage.

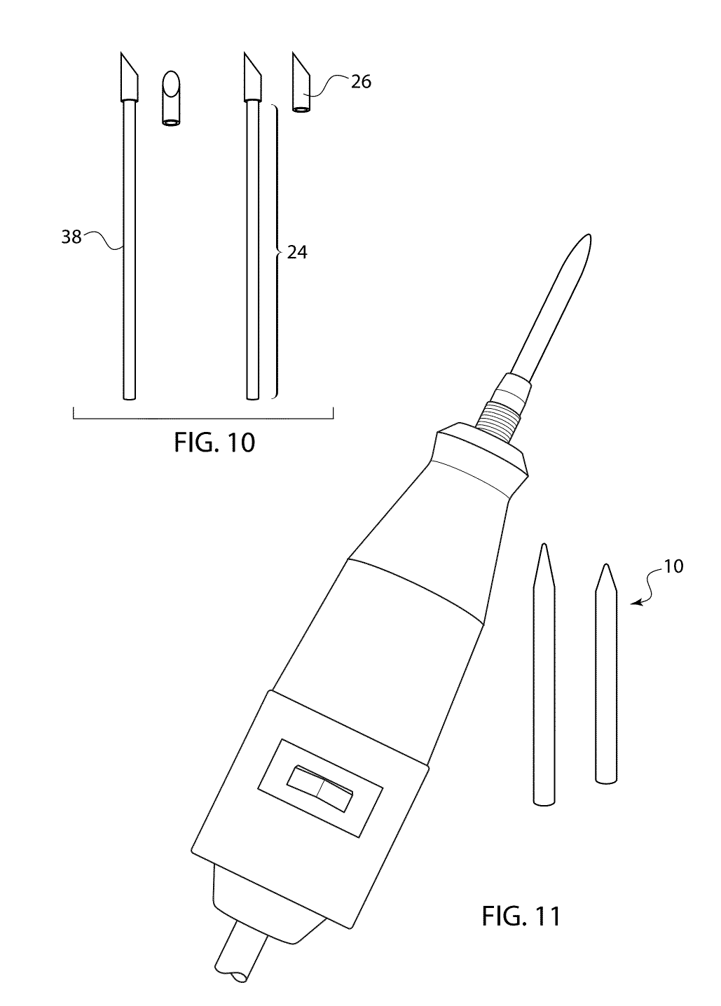

In one example, the device 10 may be provided as a porous cleaning section 26 with a stem 28. This is illustrated by FIG. 9. This can allow the porous cleaning section 26 to be physically engaged with holding section 24. In another example, the stem 28 of the cleaning section 26 may be engaged with a power tool. In another example, the body of the device 10 may be engaged with a power tool, as illustrated by FIG. 11. The power tool may be used to rotate the cleaning device 10 in use.

When the holding section 24 is integral with the cleaning section 26, it may be provided with a textured surface 30 to provide a profiled structure which functions as a gripping surface. Examples are illustrated by FIGS. 8A and 8B. The textured surface 30 may be provided as elongated grooves 32 along the body of the device 10. Although not shown, the textured surface 30 may be provided as a plurality of bumps or raised protrusions along the body of the device 10. The textured surface may be provided as any other gripping surface. The tip of the device may be used as a picking/cleaning tip.

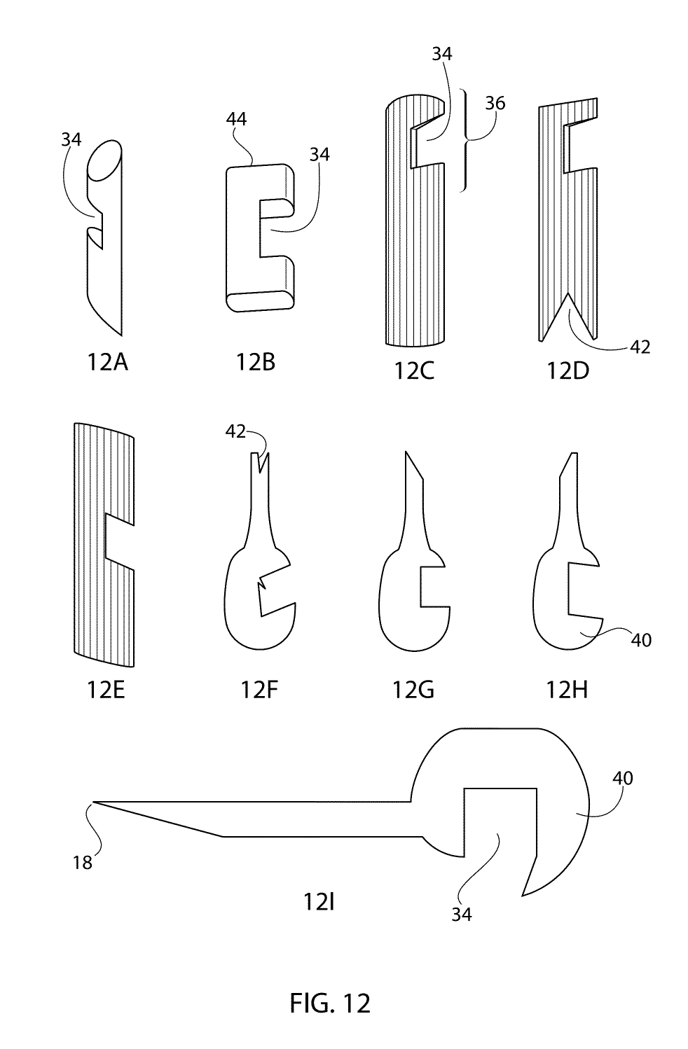

FIG. 12 illustrates porous device 10 having a recessed area 34. This embodiment may be particularly useful for cleaning the lingual surface of teeth. The recessed area 34 may be provided on any device body shape. In one example, the recessed area 34 may be provided closer to one end 36 of the device 10 than the other. This can provide a holding area for the user. FIGS. 12A-12G also illustrate various different options of device body shapes. As is shown, the device 10 may be provided with a rounded head 40. The device 10 may be provided with a pronged tip 42. The device may be provided with a sharp tip 18. The device may be provided with a blunt end 44. The body shape provided may depend upon the desired use.

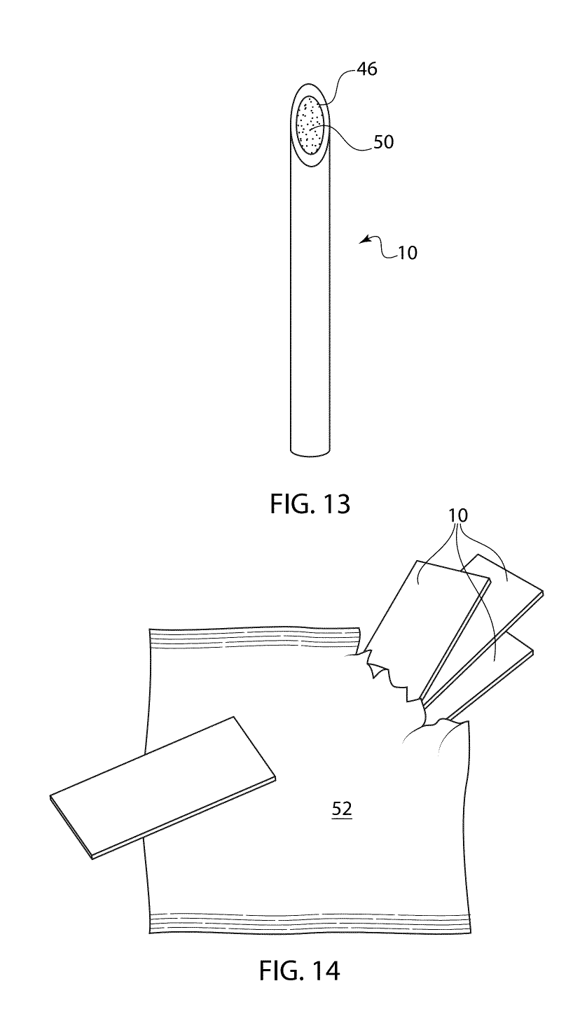

In one example, as described further below, the device 10 may be provided as having a hollowed structure 46. One example is as shown by FIG. 13. The hollowed structure 46 may be provided throughout the entirety of the device body 48. In other examples, the hollowed structure 46 may be provided only toward one end 36. In use, the hollowed structure may hold or otherwise be filled with a treatment material 50. The treatment material 50 may be in a gel or paste form and could be applied to the surface to be cleaned by squeezing of the device 10. The fibers of the device may function as a brush, tooth cleaner, crevice cleaner, or cuticle pusher once the material has been applied to the surface to be cleaned/treated. In another embodiment, the treatment material 50 may be a powder that can be applied by squeezing the device. In a further embodiment, the treatment material 50 may be a liquid that is held in the hollowed structure 46 via a non-porous lining provided inside the hollowed structure 46. In a further embodiment, the treatment material 50 may be a material that is maintained in place in a hollowed portion 46 of the device by one or more packaging components or a thin film that may be pierced, peeled, burst from squeezing or suction pressure, or otherwise removed in use.

Although bristles may be provided, it is generally envisioned that the flat surface/polishing area of the device may be used to rub against the surface for cleaning.

### Materials

The device may comprise porous fiber materials. The device may comprise sintered porous plastic materials. The device may comprise sintered porous elastomeric materials. The device may comprise a combination of both sintered porous plastic materials and sintered elastomeric materials. The device may have engineered physical properties that will not hurt sensitive surfaces, clean in a manner that is generally free of loose fiber, and at the same time provide effective cleaning and/or agent delivery action.

### Porous Fiber Device

In different embodiments, the porous fiber devices of the present invention can be die cut part from spunbond or meltblown fiber sheet. The polymers that may be made into spunbond fiber sheet include but are not limited to polyethylene, polypropylene, polyester, nylon, Rayons, polylactic acid (PLA) and polyurethane, or combinations thereof. Spunbond or meltblown material could also be made from bicomponent fibers.

In another embodiment, the porous fiber devices of the present invention can be die cut part from a wet-laid fiber sheet. The polymers that may be made into wet-laid fiber sheet include but are not limited to polyethylene, polypropylene, polyester, nylon Rayons, polyurethane, polylactic acid, acrylic, polyvinyl alcohol (PVA) and ethylene vinyl acetate (EVA) fibers, or combinations thereof. Wet-laid fiber products can also be bicomponent fibers. Wet-laid fiber products may also contain natural fibers, such as cotton fibers. Wet-laid fiber sheets are thermally bonded together to achieve desired strength.

In yet another embodiment, the porous fiber devices of the present invention can be die cut part from a dry-laid fiber sheet. The polymers that may be made into dry-laid fiber sheet are polyethylene, polypropylene, polyester, nylon Rayons, polyurethane, polylactic acid, acrylic, polyvinyl alcohol (PVA) and ethylene vinyl acetate (EVA) fibers. Dry-laid fiber product can also be bicomponent fibers. Dry-laid fiber products may also contain natural fiber, such as cotton. Dry laid fiber sheets are thermally bonded together to achieve desired strength.

In another embodiment, the porous fiber devices of the present invention can be an extruded fiber matrix made from continuous bicomponent fibers. In this case, bicomponent fibers are made using a spinning process and formed into a desired 3-D profile by pulling through a forming die. Extruded fiber products may be cut into desired lengths or shapes.

In yet another embodiment, the porous fiber devices of the present invention can be a fiber matrix made from staple bicomponent fibers. Bicomponent fibers are first made into slivers and then formed into a desired 3-D profile under heat by pulling the slivers through a forming die. Formed fiber products may be cut into desired lengths or shapes.

In various embodiments, the fibers that can be used to make the porous fiber devices of the present invention can be made by a spinning process, such as wet spinning, dry spinning, gel spinning, melt spinning and electrospinning.

The fiber that can be used to make the porous fiber devices of the present invention can be continuous fibers, stable fibers, mono-component fibers or bicomponent fibers, or combinations thereof. The fiber matrix may also contain binding particles. The binding particles may be relative low melting point polymers that bind fibers together under heat. For example, many commercial hot melt powder form adhesives could be used as binding particles, such as FX 240, FX 2030 and FX 130 from FuseTex (Hawkwell, UK).

Fibers that can be used to make the porous fiber devices of the present invention include, but are not limited to, polyethylene, polypropylene, polyesters, polyamides (Nylons), acrylic fiber, polylactic acid (PLA), polyvinyl alcohol (PVA), polyvinylidene chloride (PVDC), polyphenylene sulfide (PPS), polyvinyl chloride (PVC), cellulose and polyurethane fibers, and combinations thereof.

### Bicomponent Fibers.

A preferred kind of fiber that can be used to make the porous fiber devices of the present invention is a bicomponent fiber. Bicomponent fibers may include, but are not limited to, polyethylene/polypropylene (PE/PP), polyethylene/polyethylene terephthalate (PE/PET), polypropylene/polyethylene terephthalate (PP/PET), co-polyethylene terephthalate/polyethylene terephthalate (co-PET/PET), polylactic acid/polylactic acid (PLA/PLA), polyethylene terephthalate/Nylon (PET/Nylon), ethylene vinyl alcohol/polyethylene terephthalate (EVOH/PET), Nylon/Nylon, polyl actic acid/Nylon (PLA/Nylon), PLA/PET, EVOH/Nylon, and PET/polybutylene terephthalate (PET/PBT), polypropylene/Nylon-6, Nylon-6/PET, copolyester/PET, copolyester/Nylon-6, copolyester/Nylon-6,6, poly-4-methyl-1-pentene/PET, poly-4-methyl-1-pentene/Nylon-6, poly-4-methyl-1-pentene/Nylon-6,6, PET/polyethylene naphthalate (PEN), Nylon-6,6/poly-1,4-cyclohexanedimethy-1 (PCT), polypropylene/polybutylene terephthalate (PBT), Nylon-6/co-polyamide, polyester/polyester and polyurethane/acetal, and combinations thereof.

Bicomponent fibers may have different cross-sectional structures, such as concentric sheath, core arrangement, core/sheath, an eccentric core relative to the sheath, side-by-side arrangement of fibers, tipped, islands in sea, matrix fibril, citrus fibril, segmented pie cross-sectional structure, or combinations thereof. The bicomponent fibers can also have different shapes, such as round, trilobal, crossed, winged, or twisted structures. Bicomponent fibers that can be used to make the porous fiber dental care device of the present invention may be bound together by heat.

Fibers that can be used to make the porous fiber devices of the present invention can be also a mixture of different fibers, such as a mixture of mono-component fibers and bicomponent fibers. The fibers could be a triple-component fiber.

The mechanical strength, such as hardness, of the devices can be controlled by varying the fiber material, the fiber diameter, and/or the product density. The optimized hardness for the devices may be chosen based on the need for effective cleaning. For a dental cleaning device, the hardness is a balance among effective picking, effective brushing and effective gum stimulation. For a nail cleaning device, the hardness is a balance between effectively removing dirt from underneath nails and nail surfaces, effectively brushing surfaces of the nail, and massaging soft tissues around the nail.

One advantage of the disclosed devices over current commercially available wood-based products is the balance of effective picking, brushing, and massaging without hurting surrounding sensitive tissues. Compared with current wood-based toothpicks and plaque removers or nail cuticle sticks, the devices of the present invention have similar or better capabilities to remove dirt, but protect (or at least not damage) tissues. The sharps tips of porous devices of the present invention are more resilient than wood products. The tips are more flexible and will not split as wood picks do. The tips will not hurt soft tissues. The sharp tips may be bent during use, however by simply adjusting the angle of application, the tip may perform as originally intended due to the resilient and elastic nature of the tip.

Another advantage is that the devices may be self-supporting. They do not require a separate supporting component to support the porous oral cleaning media. The entire device may be a single piece of porous media, including an optional holding/gripping section and a cleaning section. The tip will perform as originally intended due to the resilient and elastic nature of the tip.

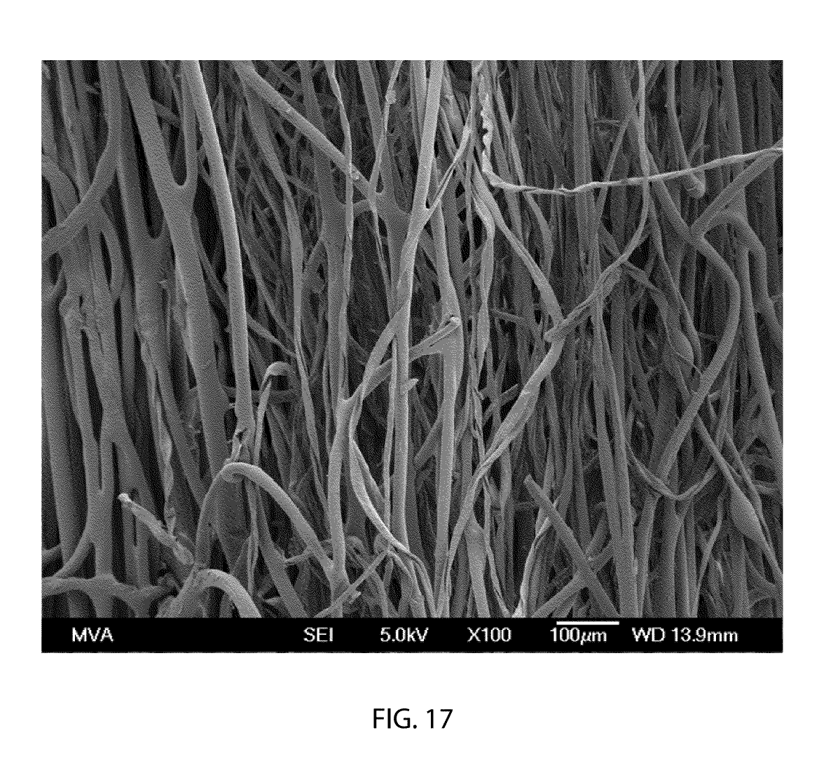

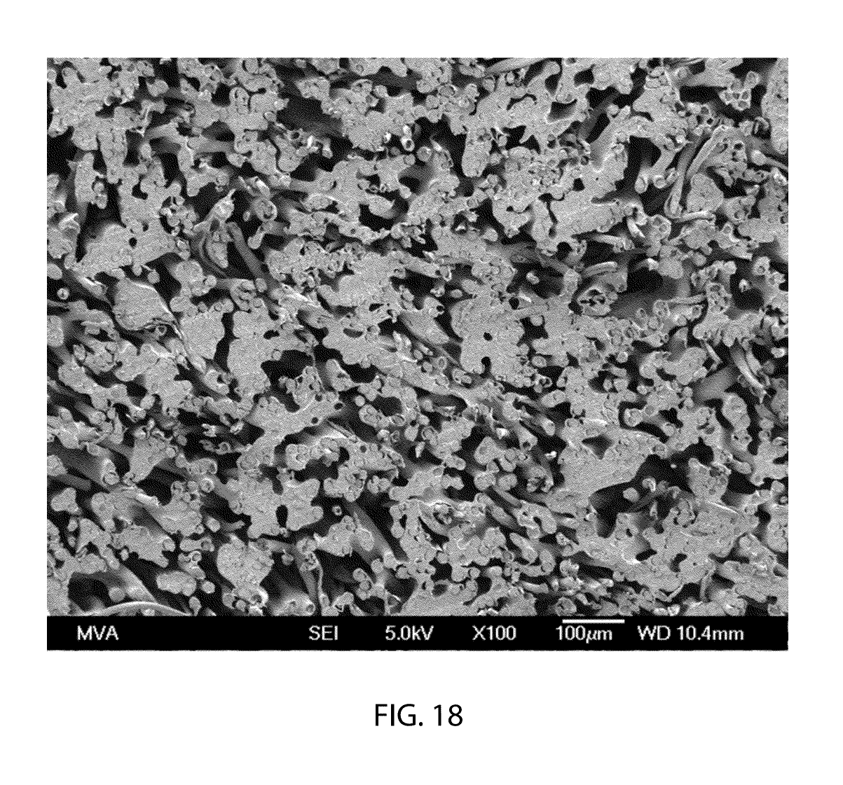

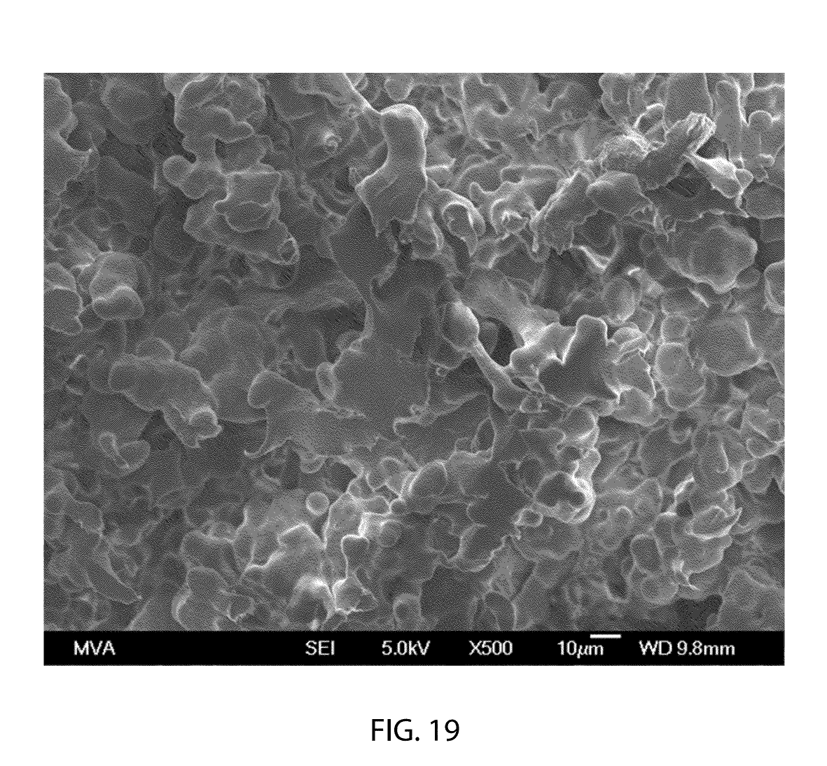

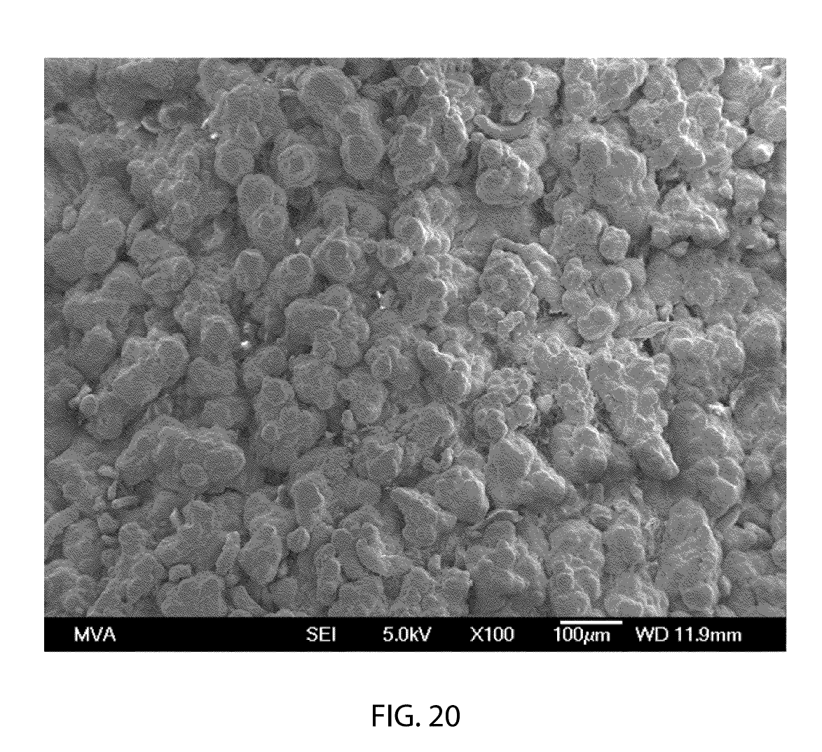

In addition to a sharp tip shape or profile, the porous devices may have flat or contoured cross-sectional profiles which may be used to scrape a hard surface, such as a tooth surface or a nail surface. The unique bound fiber structure can provide effective and safe brushing action. SEM pictures of some devices (FIGS. 17 and 18) show that the porous fiber brushing area is comprised of many fine fibers. The fine fiber based structures can give the porous devices a more gentle feeling and a better stimulation against tissues. The spaces or pores between the fibers provide capillary forces to remove the residue after polishing action, and can result in a cleaner surface.

In some embodiments, the fiber materials can be biodegradable fibers. The term biodegradable is used in this application to indicate that a component of the porous fiber dental care device can be decomposed by bacteria or other living organisms and will otherwise not take up space in a landfill. In one embodiment, the weight percentage (wt. %) of the component of the porous fiber dental care device that is biodegradable may be at least about 40%, at least about 50%, at least about 60%, at least about 70%, at least about 80% or at least about 90% of the total weight of the porous fiber dental care device. In one embodiment, the majority of the component of the device may be biodegradable.

In one embodiment, the devices may be made of synthetic bicomponent fibers. Synthetic bicomponent fibers can be partially melted by heating and fused together with void spaces (pores) among the fibers. One component in the bicomponent fiber has a lower melting temperature than another component in the bicomponent fiber. Bicomponent fibers can be fused together by melting the lower melting temperature component thereby forming porous devices.

In yet another embodiment, the devices may be made from a two component fiber blend of a synthetic bicomponent fiber and a monocomponent fiber that is carded into a sliver which is subsequently subjected to heat and pressure in an oven pultrusion process. Monocomponent fibers may be natural or synthetic. In some embodiments, bicomponent fibers may be blended with monocomponent fibers in a weight to weight ratio of about 9.5:1 9:1, 8:1, 7:1, 6:1, 5:1, or 4:1, or any number between these ratios (bicomponent fibers:monocomponent fibers). A die on the output side of the oven may form a 3-D profile that is subsequently cut into products.

Bicomponent fibers may be provided as having a core portion and a sheath portion. The sheath or core of the bicomponent fiber and/or the monocomponent fiber may be colored. The majority of the fiber blend is composed of the bicomponent synthetic fiber (about 51 wt. % to about 95 wt. %). The bicomponent synthetic fiber may be at least more than 50 wt. %, 60 wt. %, 70 wt. %, 80 wt. %, 90 wt. % or 95 wt. % of the weight of the porous fiber dental care device. The minor component of the fiber blend may be a monocomponent fiber which may be colored. This monocomponent fiber may be a synthetic fiber or a natural fiber such as a cotton fiber. The monocomponent fiber may be a solution dyed synthetic, reactive dyed synthetic, reactive dyed cotton, genetically modified colored cotton or naturally colored cotton. In another embodiment, porous fiber dental care device may be made using solution dyed bicomponent fiber. The color may also be produced by application of a dye solution after the porous fiber dental care device is made.

In one embodiment, for carding purposes, the bicomponent staple fibers and monocomponent staple fibers should be of similar denier (2-12 denier), length (about 15 mm to about 75 mm), and crimp. The monocomponent fibers have a melt or decomposition temperature at least about 10° C. higher than that of the bicomponent sheath material. In other embodiments, the monocomponent fibers have a melt or decomposition temperature at least about 20° C. higher or at least about 30° C. higher than that of the bicomponent sheath material.

In one embodiment, the fiber slivers may be bonded together by using an oven pultrusion process. The oven thermally bonds (melts) the sheath material of the bicomponent fibers to other bicomponent fibers and to the non-binding monocomponent fibers that do not melt during the pultrusion process. This process produces a cylindrical sintered porous matrix. A die may compress and shape this matrix into 3-D profile that is subsequently air cooled and cut to a desired length.

Exemplary bicomponent fibers comprising core/sheath cross-sectional structure and suitable for use are provided in Table 1.

TABLE 1
Bicomponent Fibers

| Sheath | Core |
|---|---|
| polyethylene (PE) | polypropylene (PP) |
| ethylene-vinyl acetate copolymer | polypropylene (PP) |
| (EVA) | |
| polyethylene (PE) | polyethylene terephthalate (PET) |
| polyethylene (PE) | polybutylene terephthalate (PBT) |
| polypropylene (PP) | polyethylene terephthalate (PET) |
| polypropylene (PP) | polybutylene terephthalate (PBT) |
| polyethylene (PE) | Nylon-6 |
| polyethylene (PE) | Nylon-6,6 |
| polypropylene (PP) | Nylon-6 |
| polypropylene (PP) | Nylon-6,6 |
| Nylon-6 | Nylon-6,6 |
| Nylon-12 | Nylon-6 |
| copolyester (CoPET) | polyethylene terephthalate (PET) |
| copolyester (CoPET) | Nylon-6 |
| copolyester (CoPET) | Nylon-6,6 |
| glycol-modified PET (PETG) | polyethylene terephthalate (PET) |
| polypropylene (PP) | poly-1,4-cyclohexanedimethyl (PCT) |
| polyethylene terephthalate (PET) | poly-1,4-cyclohexanedimethyl (PCT) |
| polyethylene terephthalate (PET) | polyethylene naphthalate (PEN) |
| Nylon-6,6 | poly-1,4-cyclohexanedimethyl (PCT) |
| polylactic acid (PLA) | polystyrene (PS) |
| polyurethane (PU) | Acetal |
| Co Polylactic acid (co PLA) | Polylactic acid (PLA) |

In some embodiments, fibers may comprise continuous fibers. In other embodiments, fibers comprise staple fibers. In one embodiment, for example, a fiber of a fibrous material comprises a staple bicomponent fiber. Staple fibers, according to some embodiments, have any desired length. In some embodiments, fibrous materials are woven or non-woven. In one embodiment, a fibrous material is bound together by heat. In one embodiment, porous fiber dental care device are optionally colored.

### Synthetic Fiber Materials

Synthetic fiber materials that can be used may be biodegradable or non-biodegradable. Synthetic biodegradable fibers include but are not limited to the following: poly (lactic acid) (PLA), polyhydroxyalkanoates (PHA), polyhydroxybutyrate-valerate (PHBV), and polycaprolactone (PCL), or combinations thereof.

In one embodiment, synthetic bicomponent fibers are used. Synthetic non-biodegradable bicomponent fibers that may be employed in the practice of this invention include, but are not limited to fibers constructed from the following pairs of polymers: polypropylene/polyethylene terephthalate (PET), polyethylene (PE)/PET, polypropylene/Nylon-6, Nylon-6/PET, copolyester/PET, copolyester/Nylon-6, copolyester/Nylon-6,6, poly-4-methyl-1-pentene/PET, poly-4-methyl-1-pentene/Nylon-6, poly-4-methyl-1-pentene/Nylon-6,6, PET/polyethylene naphthalate (PEN), Nylon-6,6/poly-1,4-cyclohexanedimethy-1 (PCT), polypropylene/polybutylene terephthalate (PBT), Nylon-6/co-polyamide, polyester/polyester and polyurethane/acetal, or combinations thereof.

### Natural Fiber Materials

In some embodiments, natural fiber materials can be used in combination with the synthetic bicomponent fibers. These natural fiber materials include, but are not limited to: cotton fiber, Rayon, Tencel, silk, and wool. Cottons can be any type of cotton, including Pima, Egyptian Cotton, Upland cotton, and Asiatic cotton. Naturally biodegradable cellulose based fibers include vegetable fibers, wood fibers, animal fibers and some man-made cellulose based fibers, or combinations thereof. Vegetable fibers may include cotton fibers.

The cotton can be purchased commercially from many sources such as Cotton Works Inc. (Gaffney, S.C., USA), Frontier Spinning Mills Inc. (Stanford, N.C., USA), and Parkdale (Gastonia, N.C., USA). There are also a number of companies that dye cotton. Cottons can also be dyed by many methods. One desire for the dyed cotton for this application is its good color fastness. The dye should generally stay on the cotton surface and not move with any fluid applied to the device. One type of dye for this application is a reactive dye that can form covalent bonds with cotton. The reactive dyes that can be used in this application include, but are not be limited to Procion MX series dyes, Cibacron F, Drimarene K, Remazol or vinyl sulfone dyes, Levafix, Procion H and H-E, or Novacron from Huntsman (The Woodlands, Tex., USA).

The staple fiber can be long or short. It may be desirable to have similar lengths of the natural fiber and of the synthetic bicomponent fiber. Synthetic fibers can be cut to a desired length. A good match provides better blending (dispersion of the lower concentrate fiber) and better carding. Furthermore, this yields adequate tensile strength for the pultrusion process. Fibers that are too short will not be carded properly into adequate slivers for the pultrusion process. The fibers used in this application are generally from about 0.5 to about 2.5 inches in length. In one embodiment cotton fibers are from about 0.5 to about 1.5 inches in length. In one embodiment synthetic bicomponent fibers are from about 0.5 to about 2.5 inches in length, from about 1.0 to about 1.5 inches in length, or from about 1.5 to about 2.0 inches in length.

In one specific embodiment, the device may have synthetic bicomponent fibers from about 51 wt. % to about 100 wt. % and other synthetic or natural monocomponent fibers from about 0 wt. % to about 49 wt. %. In other embodiments, the device may have synthetic bicomponent fibers from about 60 wt. % to about 100 wt. %, or 70 wt. % to about 100 wt. %, and other synthetic or natural fibers from about 0 wt. % to about 40 wt. % or from about 0 wt. % to about 30 wt. %, respectfully. The fibers may be biodegradable. In other embodiments, devices may have bicomponent fibers from 70 to 95 wt % and hydrophilic monocomponent fibers from 5 to 30 percent (wt %).

The colored fibrous components that may be employed in the practice of this invention include, but are not limited to: naturally colored cotton fiber (Vreseis Ltd. trade name: Fox fiber), and dye colored cotton, Rayon, Tencel, silk, wool, polyvinyl alcohol (PVA) or acrylic fibers.

The device may be reinforced with a polymer binding. The polymers could be used to reinforce porous fiber media are thermosetting resins, such as polyurethanes, phenolic resins, polyesters, melamine, epoxy resins, or combinations thereof. Such thermosetting polymers provide porous fiber media with enhanced strength, hardness, and abrasion resistance. Thermosetting resins could be added to porous fiber media after or during porous fiber media forming process. The process of adding thermosetting resin to porous fiber media is described in following patents: U.S. Pat. No. 3,442,739, U.S. Pat. No. 4,104,781, U.S. Pat. No. 6,117,260, and U.S. Pat. No. 7,043,791.

The porous fiber cleaning device could be coated with other polymer coatings. The polymer coating could be applied to the external surface of porous fiber product by polymer spray coating, co extrusion or dip coating.

Processing Fibers into a Device

There are many ways to convert fiber into a porous device. PCT/US2010/020514 teaches a method of making hydrophilic porous wicks for vaporizable materials. The process described in this PCT application could be used to make a device as described herein. The process described in PCT/US02/11828 may also be used. The fiber material and process of forming a porous fiber matrix described in U.S. Pat. No. 5,633,082; U.S. Pat. No. 7,888,275; and U.S. Pat. No. 4,729,808 may be used to make a device. Generally known commercial ways of making a fiber matrix by spinning the fibers and downstream processes could be used to manufacture the devices described herein.

### Sintered Porous Plastic and Elastomeric Device

In other embodiments, the devices described herein may be made of other materials. For example, the devices may be made of sintered porous plastics. The devices may be made of sintered porous polymers. The devices may be made of sintered porous elastomers. The devices may be made of a combination of one or more sintered porous plastics and one or more elastomers. The sintered devices described may include sintered porous plastic, sintered porous elastomeric material, or a sintered media that comprises both plastic and elastomeric particles.

Example of non-limiting suitable plastics comprise polyolefins, polyamides, poglyesters, rigid polyurethanes, polyacrylonitriles, polycarbonates, polyvinylchloride, polymethylmethacrylate, polyvinylidene fluoride, polytetrafluoroethylene, polyethersulfones, polystyrenes, polyether imides, polyetheretherketones, or polysulfones, and combinations and copolymers thereof.

In some embodiments, a polyolefin comprises polyethylene, polypropylene, and/or copolymers thereof. Polyethylene, in one embodiment, comprises high density polyethylene (HDPE). High density polyethylene, as used herein, refers to polyethylene having a density ranging from about 0.93 g/cm³ to about 0.97 g/cm³. Polyethylene, in one embodiment, comprises medium density polyethylene. Medium density polyethylene (MDPE), as used herein, refers to polyethylene having a density ranging from about 0.92 g/cm³ to about 0.93 g/cm³. Polyethylene, in one embodiment, comprises low density polyethylene. Low density polyethylene (LDPE), as used herein, refers to polyethylene having a density ranging from about 0.91 g/cm³ to about 0.92 g/cm³. Polyethylene, in one embodiment, comprises linear low density polyethylene. Linear low density polyethylene (LLDPE), as used herein, refers to polyethylene having a density ranging from about 0.91 g/cm³ to about 0.92 g/cm³. Polyethylene, in one embodiment, comprises very low density polyethylene. Very low density polyethylene (VLDPE), as used herein, refers to polyethylene having a density ranging from about 0.89 g/cm³ to about 0.91 g/cm³. In another embodiment, polyethylene comprises ultrahigh molecular weight polyethylene (UHMWPE). Ultrahigh molecular weight polyethylene, as used herein, refers to polyethylene having a molecular weight greater than 1,000,000. In another embodiment, polyethylene comprises very high molecular weight polyethylene (UHMWPE). Very high molecular weight polyethylene, as used herein, refers to polyethylene having a molecular weight greater than 300,000 and less than 1,000,000. The polyethylenes may be crosslinked polyethylenes.

In another embodiment, one or more elastomeric materials may form the sintered porous nail treatment device described herein. The elastomeric materials may be sintered to form the device described herein. In other embodiments, one or more elastomeric materials may be added to the sintered porous plastic materials. When an elastomeric material is used, the device may have elastic properties. For example, in some embodiments, the device may have elastic properties and can comprise elastomeric materials. Elastomeric materials may also be used to form the device described herein. Non-limiting examples of suitable elastomers comprise thermoplastic elastomers (TPE). Thermoplastic elastomers comprise polyurethanes and thermoplastic polyurethanes (TPU). Thermoplastic polyurethanes, in some embodiments, include multiblock copolymers comprising a polyurethane and a polyester or polyether, or combinations thereof.

In other embodiments, elastomers suitable for use comprise polyisobutylene, polybutenes, butyl rubber, or combinations thereof. In another embodiment, elastomers comprise copolymers of ethylene and other monomers such as ethylene-propylene copolymer, referred to as EPM, ethylene-octene copolymer, and ethylene-hexene copolymer. In another embodiment, elastomers comprise copolymers of propylene and other monomers such as ethylene-propylene copolymer, referred to as EPM, ethylene-octene copolymer, and polyethylene-hexene copolymer. In a further embodiment, elastomers comprise chlorinated polyethylene or chloro-sulfonated polyethylene, or combinations thereof.

In some embodiments, elastomers suitable for use in sintered devices comprise 1,3-dienes and derivatives thereof 1,3-dienes include styrene-1,3-butadiene (SBR), styrene-1,3-butadiene terpolymer with an unsaturated carboxylic acid (carboxylated SBR), acrylonitrile-1,3-butadiene (NBR or nitrile rubber), isobutylene-isoprene, cis-1,4-polyisoprene, 1,4-poly(1,3-butadiene), polychloroprene, and block copolymers of isoprene or 1,3-butadiene with styrene such as styrene-ethylene-butadiene-styrene (SEBS), or combinations thereof. In other embodiments, elastomers comprise polyalkene oxide polymers, acrylics, or polysiloxanes (silicones) or combinations thereof.

In a further embodiment, elastomers suitable may comprise Forprene, Laprene, Skypel, Skythane, Synprene, Rimflex, Elexar, Flexalloy, Tekron, Dexflex, Typlax, Uceflex, Dexflex, Engage, Hercuprene, Hi-fax, Innopol, Novalene, Kraton, Muti-Flex, Evoprene, Hytrel, Nordel, Versify, Vistamaxx, Viton, Vector, Silastic, Santoprene, Elasmax, Affinity, Attane, and Sarlink, etc., or combinations thereof.

As described, the devices may comprise both elastomeric particles and plastic particles. For example, at least one elastomer may range from about 10 weight percent to about 90 weight percent. In other embodiments, at least one elastomer may range from about 20 weight percent to about 80 weight percent. In another embodiment, at least one elastomer may range from about 30 weight percent to about 70 weight percent. In a further embodiment, at least one elastomer may range from about 40 weight percent to about 60 weight percent.

In some embodiments, the polymeric particles that can be used in the sintered porous device may be biodegradable polymers. In one embodiment, the wt. % of the component of the sintered porous polymeric nail treatment device that is biodegradable is at least about 40%, at least about 50%, at least about 60%, at least about 70%, at least about 80% or at least about 90% of the total weight of the device. In one embodiment, the majority component of the sintered porous polymeric nail treatment device may be biodegradable.

### Optional Plasma Treatment

Optionally, the devices may be plasma treated. The devices can be optionally treated with high energy plasma. Plasma treatment can be a batch process at low pressure or an inline process at or above atmospheric pressure. Plasma treatment can be any one of commonly employed industrial plasma processes, such as radiofrequency (RF) or microwave plasma. The plasma treatment can also be a low pressure or normal pressure air plasma process. In a specific application, plasma treatment may be a low pressure, gas plasma treatment process. The devices may be placed in a chamber for a specified time, energy level, and gas flow rate.

The gas can be oxygen, but other gases can be used, such as nitrogen, argon, hydrogen and any combination thereof. Other inert gases or vapors such as helium, water, or methanol can be used. Other molecules, such as alcohol or acrylic acids can be used in the plasma chamber to make the polymer fiber more hydrophilic. The gas flow rate may be controlled to maintain the chamber at a pressure about 100 mtorr and treatment time generally is 2 minutes to 30 minutes. Various exposure times, pressures, and energies are used during the plasma process depending on the desired product requirements. It is widely known that plasma treatment conditions depend on the machine design, sample size, power etc. One of ordinary skill in the art can modify conditions for different component parts and on different plasma machines. A plasma treatment device that feeds inline to the pultrusion process and does not require vacuum conditions and operates at positive pressures (above ambient atmospheric pressure) may be used. Experimental results have shown that plasma treating the devices can increase capillary wicking.

The plasma process makes the device more hydrophilic. The plasma treatment process can create hydrophilic moieties on the surface of the molecules. These moieties increase the surface energy of materials of the device, making them more hydrophilic. The cross sectional area determines the amount of fluid that can be transported through the device for a given density. Larger diameter devices may be harder than smaller devices.

### Porosity/Other Features

The disclosed devices are generally porous. The ranges described in this section are relevant for devices manufactured from fibrous materials, elastomeric materials, plastic materials, or any combination thereof. In one embodiment, for example, the device may have a porosity ranging from about 10% to about 90%. In another embodiment, the device may have a porosity ranging from about 20% to about 80% or from about 30% to about 70%. In a further embodiment, a nib of the device may have a porosity ranging from about 40% to about 60%.

An average pore size may range from about from about 1 μm to about 200 μm. In other embodiments, devices may have an average pore size ranging from about 2 μm to about 150 μm, from about 5 μm to about 100 μm, or from about 10 μm to about 50 μm. In another embodiment, devices may have an average pore size less than about 1 μm. In one embodiment, devices may have an average pore size ranging from about 0.1 μm to about 1 μm. In a further embodiment, devices may have an average pore size greater than 200 μm. In one embodiment, devices may have an average pore size ranging from about 200 μm to about 500 μm or from about 500 μm to about 1 mm.

The porous devices may hold water or other liquid at a capacity of from about 0.2 grams of water/liquid per gram of dry porous media to about 5 grams of water/liquid per gram of dry porous media. In other examples, they may hold from about 0.4 grams of water/liquid per gram of porous media to about 4 grams of water/liquid per gram of porous media. In another example, they may hold from about 0.6 grams of water/liquid per gram of porous media to about 3 grams of water/liquid per gram of porous media. In another example, they hold from about 0.8 grams of water/liquid per gram of porous media to about 2 grams of water/liquid per gram of porous media.

Devices may have a density ranging from about 0.1 g/cm³ to about 1 g/cm³. In other embodiments, devices may have a density ranging from about 0.2 g/cm³ to about 0.8 g/cm³ or from about 0.4 g/cm³ to about 0.6 g/cm³. In a further embodiment, devices may include at least one plastic and at least one elastomer has a density greater than 1 g/cm³. In other examples, the device may have a density from about 0.2 g/ml to about 1.0 g/ml, or from about 0.3 g/ml to about 0.9 g/ml or from about 0.4 g/ml to about 0.8 g/ml.

Devices made of sintered porous plastic may have a tensile strength ranging from about 10 to about 5,000 psi as measured according to ASTM D638. They may have a tensile strength ranging from about 50 to 3000 psi or from about 100 to 1,000 psi as measured according to ASTM D638. In some embodiments, sintered porous plastic devices may have an elongation ranging from 10% to 500%.

Any of the above materials may be used to form the devices into the shapes shown in the figures and described herein. The manufacture of the device may be done according to current manufacturing methods for porous materials having various shapes using different and properly shaped molds to form the sintered porous dental care devices described herein.

### Additives/Treatment Materials

### Dental Agents:

In some embodiments, the device may be provided as a dental care device. It is possible for a porous dental care device to comprise dental cleaning agents. The dental care device may either be provided as a porous sintered dental care device or as a porous fiber dental care device. Any of the dental agent options described herein may be used with either embodiment. Dental cleaning agents may be optionally employed to enhance the cleaning efficiency and experience of using the dental care device to clean teeth. Dental cleaning agents are well known in the dental industry as agents to prevent cavities and periodontal diseases. The dental agents may include but are not limited to antimicrobial agents, anti-cavity, surfactants, flavorings, polishing agents, cleaning agents, or other ingredients in mouthwash or toothpaste. Other additives such as colorants and pH control agents may also be added into the solution.

For example, the dental agents may include, but are not limited to, alcohol, benzydamine, betamethasone, cetylpyridinium chloride, chlorhexidine digluconate, essential oils, fluorides, hydrogen peroxide, phenol, povidone, iodine, sanguinarine, baking soda, sodium chloride, tetracycline, tranexamic acid, zinc chloride, triclosan, eucalyptol, menthol, methyl salicylate, thymol and sodium lauryl sulfate (SLS).

Many commercially available mouthwash products can be used as solutions for treating porous fiber dental care devices. These commercial mouthwash products can be used directly without any modification. Commercially available include, but not limited to, Colgate, Listerine, Oral-B, Scope, ACT, Cepacol, Corsodyl, Sarakan and Tantum verde, etc., or combinations thereof. These commercial mouthwashes are considered as pre-formulated dental/oral cleaning agents.

Oral cleaning agents may also include antimicrobial agents. These options include without limitation triclosan, cetylpyridinium chloride, copper (II) compound, such as copper chloride, copper fluoride, copper sulfate and copper hydroxide; zinc ion products, such as zinc citrate, zinc sulfate, zinc glycinate and sodium zinc citrate; phthalic acid and salts; hexetidine; octenidine; sanguinarine; benzalkonium chloride; salicylanilide; domiphen bromide; alkylpyridinium chloride, such as cetypyridinium chloride, tetradecylpyridinium chloride and N-tetradecyl-4-ethylpyridinium chloride; octenidine; iodine; sulfonamides; bisbiguanides, such as alexidine, chlorhexidine, chlorhexidine, chlorhexidine acetate, chlorhexidine digluconate; phenolic and pineridino derivatives, such as delmopinol and octopinol, magnolia extract, grape seed extract; phenol; thymol; eugenol; menthol; geraniol; carvacrol; citral; eucalyptol; catechol; 4-allylcatechol; hexyl resorcinol; halogenated bisphenolics; salicylate; antibiotics, such as augmentin, amoxicillin, tetracycline, kanamycin and clindamycin, etc., or combinations thereof. These antimicrobial agents could be in the solution at total concentration between about 0.01% to about 5% in a treating solution for the oral cleaning device.

The cleaning devices may comprise one or more antimicrobial enhancing agents. Antimicrobial enhancing agents are polymers promoting retention of antimicrobial agent on the oral surfaces. They are polymers with anionic groups. One example of antimicrobial enhancing agent is copolymer of polyvinyl methyl ether and maleic anhydride (PVME/MA) under the Gantrez brand name from ISP, Wayne, N.J.

One or more flavorants may be added to the cleaning device. They may be coated onto the device, or impregnated into the device, or both. Flavorants that may be used include, but are not limited to, peppermint, spearmint, wintergreen, Anethole anise, apricot, bubblegum, cinnamon, fennel, lavender, neem, ginger, vanilla, lemon, orange, banana, strawberry, cherry, pineapple, apple, grapefruit, coffee, cocoa, peanut almond and pine, etc., or combinations thereof.

In one embodiment, the cleaning device may be optionally colored. Colorants that could be used include, but are not limited to, food dyes, such as FD&C red #6 and #33, blue #1, yellow #5, or combinations thereof. The colorant could also be a pigment based colorant. It is generally desirable that any colorant, flavorant, or other additive be food safe and ingestible.

The cleaning devices may contain one or more inorganic materials that provide dental and/or oral benefits. These chemicals may include, but are not limited to, fluorides, such as sodium fluoride, stannous fluoride, or other anti-caries agents. They may reduce apatite solubility, remineralize carious lesions, and reduce microbial adhesion to the tooth surface. Phosphates, such as mono and dibasic phosphates, may act as acid etching agents in conjunction with fluoride ions. They may help enhance the enamel's resistance to cariogenic attack by promoting formation of fluorapatite crystals. Sodium bicarbonate (baking soda) could function as a cleaning, acid neutralization and deodorizing agent. Sodium acetate may be added as an alkalizing agent and expectorant.

The cleaning devices may contain one or more surfactants. Surfactants may help loosen and remove plaque. The surfactants could be cationic surfactants, anionic surfactants, non-ionic surfactants and amphoteric surfactants, or combinations thereof. The surfactants may include quaternary ammonium compound with C₈₋₂₀ aliphatic chain, sodium salts of C₈₋₂₀ alkyl sulfate, polyoxyethylene sorbitan esters, C8-20 aliphatic compounds with both positive charge and negative charge, or combinations thereof. Other examples include Poloxamer 407, poloxamer 338 and sodium lauryl sulfate (SLS), or combinations thereof.

The cleaning devices may contain one or more sweeteners that can provide better taste and a more comfortable oral feeling. The sweeteners may include, but are not limited to, sodium saccharin, sorbitol, mannitol and aspartame, or combinations thereof.

The cleaning devices may contain one or more humectants, such as triacetin, propylene glycol, glycerin, low molecular weight polyethylene glycol, or combinations thereof. The cleaning devices may contain one or more antioxidants, such as vitamin A, vitamin C and vitamin E, or combinations thereof. The cleaning devices may contain a sialagogue for stimulating saliva generation. These may include food acids, such as citric acid, lactic acid, malic acid or succinic acid, or combinations thereof.

The cleaning devices may contain one or more anti-inflammatory agents, such as steroidal and nonsteroidal agents. The cleaning devices may contain one or more desensitizing agents, such as potassium salts, like potassium citrate, potassium chloride and potassium sulfate, or combinations thereof. The cleaning devices may contain one or more thickening agents. The thickening agents may include, but are not limited to, carboxyvinyl polymers, such as Carbopol; i-carrageenan; cellulosic polymers, such as carboxymethylcellulose (CMC); water soluble starches; polyvinylpyrrolidone; natural gums, such as xanthan gum, guar gum and karaya gum, or combinations thereof.

The cleaning devices may also contain chemicals for whitening the teeth such that the cleaning device may also function as a tooth whitening device. The chemicals that could whiten the tooth surface include but are not limited to peroxy compounds, chlorine dioxide, chlorites and hypochlorites and salts, or combinations thereof. Peroxy compounds may include, but are not limited to, hydrogen peroxide, peroxide of alkali metal, organic peroxide compounds and organic peroxide acids and salts. Organic peroxide compounds may include, but are not limited to, carbamide peroxide, glyceryl hydrogen peroxide, benzyl peroxide, or a polymer-peroxide complex such as a polyvinylpyrrolidone-hydrogen peroxide complex.

Other than dental cleaning agents, any chemical that may provide benefits to dental care or cure a dental disease could be incorporated into a porous dental care device, those chemicals involve, but not limited to, antibiotics, desensitizers, disinfectants, tooth whiteners, natural oils, and anesthetic agents, as known to one of ordinary skill in the art.

The dental care devices can be used alone or used as tips or nibs with a holder. In one embodiment the dental care device can have a relatively rigid portion, like a stem or a shank for insertion into a holding device (such a chuck on a drill) and a softer region for contacting and polishing surfaces of teeth. The dental care devices are generally intended to be disposable devices.

The dental care devices described provide a more gentle polishing action compared to traditional polishing devices and will not damage gums or the skin surrounding a polished target, such as gums. The devices are self-supporting and strong enough to be inserted into an electrical polishing device. The pore structure makes it possible for the device to hold dental agents and provide a more efficient polishing effect while not damaging soft tissues.

Manicure and Pedicure, Nail Cleaning and/or Treatment Agents.

In some embodiments, the device may be provided as a manicure or pedicure device, or other nail treatment device. It is possible for a manicure/pedicure device to comprise one or more nail treatment agents. The manicure/pedicure device may either be provided as a porous sintered device or as a porous fiber device. Any of the dental agent options described herein may be used with either embodiment.

In some embodiments, the nail treatment device may comprise one or more nail cleaning and/or treatment agents. The treatment agents may include one or more antifungal agents. They include without limitation Polyene based antifungals, including, Amphotericin B, Candicidin, Filipin, Hamycin, Nystatin, Pimarcin, Rimocidin; Imidazole based antifungals, including Bifonazole, Ketoconazole etc.; Triazole based antifungals, including albaconazole, fluconazole voriconazole etc.; Abafungin; allylamine based antifungals, including Amorolfin, Butenafine, Naftifine and Terbinafine; 5-Fluorxytosine, Griseofilvin, potassium iodide, benzoic acid, Ciclopirox, crystal violet and Balsam of Peru, or combinations thereof. One example of a commercial nail treatment device is FUNGI NAIL® antifungal solution (distributed by Kramer Consumer Healthcare based in Coral Gables, Fla.).

The treatment agents may include one or more antimicrobial agents. They include without limitation triclosan, cetylpyridinium chloride, copper (II) compound, such as copper chloride, copper fluoride, copper sulfate and copper hydroxide; zinc ion products, such as zinc citrate, zinc sulfate, zinc glycinate and sodium zinc citrate; phthalic acid and salts; hexetidine; octenidine; sanguinarine; benzalkonium chloride; salicylanilide; domiphen bromide; alkylpyridinium chloride, such as cetypyridinium chloride, tetradecylpyridinium chloride and N-tetradecyl-4-ethylpyridinium chloride; octenidine; iodine; sulfonamides; bisbiguanides, such as alexidine, chlorhexidine, chlorhexidine, chlorhexidine acetate, chlorhexidine digluconate; phenolic and pineridino derivatives, such as delmopinol and octopinol, magnolia extract, grape seed extract; phenol; thymol; eugenol; menthol; geraniol; carvacrol; citral; eucalyptol; catechol; 4-allylcatechol; hexyl resorcinol; halogenated bisphenolics; salicylate; antibiotics, such as augmentin, amoxicillin, tetracycline, kanamycin and clindamycin, etc., or combinations thereof. In some embodiments, the antimicrobial agent(s) may be in the solution at total concentration between 0.01% to 5% in treating solution for the device.

The nail treatment devices may comprise one or more antimicrobial enhancing agents. Antimicrobial enhancing agents are polymers promoting retention of antimicrobial agent on the nail surfaces. They are polymers with anionic groups. One example of antimicrobial enhancing agent is copolymer of polyvinyl methyl ether and maleic anhydride (PVME/MA) under the Gantrez brand name from ISP, Wayne, N.J.

Flavorants could be optionally used in the devices described herein. Options include, but are not limited to, peppermint, spearmint, wintergreen, Anethole anise, apricot, bubblegum, cinnamon, fennel, lavender, neem, ginger, vanilla, lemon, orange, banana, strawberry, cherry, pineapple, apple, grapefruit, coffee, cocoa, peanut almond and pine, etc., or combinations thereof.

Colorants could be used in the device. Options include, but are not limited to, food dyes, such as FD&C red #6 and #33, blue #1, yellow #5, or combinations thereof. The colorant could also be a pigment based colorant. The nail treatment device may contain one or more inorganic materials that provide nail benefits. These chemicals include, but are not limited to, inorganic compound contain iron, zinc, magnesium copper, selenium etc., or combinations thereof.

The devices may contain one or more surfactants. Surfactants may help loosen dirt and/or oils. The surfactants could be cationic surfactants, anionic surfactants, non-ionic surfactants and amphoteric surfactants such as quaternary ammonium compound with C₈₋₂₀ aliphatic chain, sodium salts of C₈₋₂₀ alkyl sulfate, polyoxyethylene sorbitan esters, C₈₋₂₀ aliphatic compounds with both positive charge and negative charge, or combinations thereof. Other examples include Poloxamer 407, poloxamer 338 and sodium lauryl sulfate (SLS).

The nail treatment device may contain a humectant, such as triacetin, propylene glycol, glycerin, low molecular weight polyethylene glycol, or combinations thereof. The nail treatment device may also contain one or more antioxidants or vitamins, including but not limited to vitamin A, vitamin B, vitamin C, vitamin D and vitamin E; amino acids, including but not limited to Aspartic acid, Glutamic acid, Serine, Glycine, Histidine, Arginine, Threonine, Alanine, Proline, Tyrosine, Valine, Methionine, Lanthionine, Leucine, Phenylalanine, Lysine and Cystine, or combinations thereof.

The nail treatment device may also contain one or more chemicals that provide one or more benefits to nails or nail surfaces. These may include but are not limited to keratin, equisetum arvense, carrageena, Aucoumea klaneana extract, ginseng root extract, omega-3 fish oil, olive oil, coconut oil, cuticle oil, a cuticle softening agent, tea tree oil, or combinations thereof.

The nail treatment device may contain a nail polish remover compound, such that the device may be used to remove nail polish. The compound may generally be impregnated, sprayed, or otherwise formed into the device, at least at the tip of the device. In one example, the device may be stored in a package such that the nail polish remover compound remains in a liquid-like form. In another example, the nail polish remover compound is thickened so that it functions like a gel or paste that can be stored in a hollowed portion of the device. In another example, the nail polish remover compound is dried into the device and the device can be rehydrated with water or another liquid so that the nail polish remover compound is re-activated. These options are outlined in more detail below.

The nail treatment device may also contain one or more thickening agents. Optional thickening agents include, but not limited to, carboxyvinyl polymers, such as Carbopol; i-carrageenan; cellulosic polymers, such as carboxymethylcellulose (CMC); water soluble starches; polyvinylpyrrolidone; natural gums, such as xanthan gum, guar gum and karaya gum, or combinations thereof.

Nail treatment agents may be employed to enhance the cleaning efficiency and experience of using the nail treatment devices disclosed herein. Application of nail treatment agents may generally be accomplished by contacting a device with a solution or emulsion containing one or more nail treatment agents. A solution containing a variety of nail treatment agents may also be sprayed onto the device. Any commercially available nail cleaning product(s) can be used as the solutions for cleaning or treating the nail treatment devices. These commercial nail cleaning, polishing and coating removal products can be used directly without any modification.

In an alternate embodiment, the disposable self-supporting porous nail treatment device may be as a nail polish applicator. The disposable self-supporting porous nail treatment device may be dipped into a nail polish fluid and saturated with nail polish fluid. The sharp tip of the device may be used to paint the nail edges and the flat section of the device may be used to paint the nail plate. The sharp tip of the device may easily provide sharp painted nail edges without over painting surrounding skin areas.

### Other Agents:

In some embodiments, the device may be provided as a cleaning device for electronics, medical devices, weaponry, personal hygiene, or any other uses. It is possible for a porous cleaning device to include one or more cleaning agents or lubricants. Agents may include but are not limited to alcohol, Lysol, bleach (such as Clorox® distributed by the Clorox Company based in Oakland, Calif.), ammonia, vinegar, wood cleaning oil, grout cleaner, grout sealant, spackle, paint, machine lubrication oil, gun oils, grease, polisher gels, silicon oils, WD-40® (distributed by the WD-40 Company based in San Diego, Calif.), anti-bacterial wound treatment, antibacterial cleaning agent, a surfactant or soap, or any other cleaning or lubrication substance, or any combination thereof.

### Incorporation of Cleaning Agent or Treatment Solution

Any of the above described solutions agents, or treatment materials are considered within the scope of this disclosure, and are generally referred to as “agents” in the section. The term “agents” includes a single agent or combinations of multiple agents. They may be incorporated into the device and any number of ways. Non-limiting examples follow.

In one example, the agent can be in powder form and entrapped in a porous fiber devices. Agents may be dusted onto fibers forming the slivers and formed into the fiber matrices. The agents can be released onto the surface when the porous fiber device contacts the surface to be cleaned. For the dental device, the agent may be released upon contact with the oral or tooth surface and is wetted by saliva in the mouth. For the nail or other cleaning devices, the agent can be released to the surface when the device is hydrated with water or another solution.

In another example, the agent can be blended with polymer powders and co-sintered into sintered porous plastic or elastomeric devices. For example, the agent can be in powder form and entrapped in sintered porous polymeric oral cleaning devices. Agents can be blended with polymer powders and co-sintered into sintered porous polymeric oral cleaning devices. Oral cleaning agents in sintered porous polymeric oral cleaning devices can be released onto the oral or tooth surfaces when the sintered porous polymeric oral cleaning device contacts oral surfaces and becomes wet with saliva in the mouth.

In another example, the agent may be sprayed or painted onto the devices.

The amount of agent in a dry porous device can vary from about 0.1 wt. % to about 10 wt. %.

In a further example, an agent can also be introduced into a device (either a fiber device or a sintered porous polymeric device) by immersing the device into a solution containing one or more agents. In one example, the wet porous device can be dried, leaving the one or more agents impregnated in the porous fiber device. In another example, the device can be placed in its wet condition into a package and sealed. When cleaning is desired, an individual can open the package and use the wet porous cleaning device.

The devices may be pre-wetted with one or more treatment solutions and placed in an air-tight or hermetically sealed package. FIG. 14 illustrates a porous fiber device 10 wetted with an oral hygiene solution and packaged in a sealed packaging 52. The package may be opened on demand with a tearing action when needed.

The capillary force generated by the porous structure can keep the treatment solution inside the porous device. When the device is applied to the surface to be cleaned, the treatment solution may be released by contact or squeezing.

The percentage of agent in a device can vary from 1% to 100%. One hundred percent means that the agent fully saturates the device, or that 100% of void spaces in the device are occupied with the agent (usually a solution). The agent may be introduced into the device by immersing the porous device into the agent. Immersing the porous device into the agent results in a porous device that is fully or at least partially saturated with the agent. The saturated device may then be used or optionally placed in a sealable package to maintain the device's moisture. The agent could occupy 10%, 20%, 30%, 40%, 50%, 60%, 70%, 80%, 90% or 100% of the void space in the device. The device with agent is then used or optionally placed in a sealable package to maintain the device's moisture. The device may be packaged in its wet/solution filled state so that the device is still slightly damp when the package is opened by the user. It is also possible to allow the agent to dry on the device prior to packaging. The agent may be effective in its dry state, or the device may be rehydrated prior to use. Agents can also be introduced into the device by spraying. Agents can also be selectively applied to a specific region of a device.

In another example, the agent can be introduced with the device during a packaging step. Before, during or after placement of a dry porous device into a package, a controlled amount of agent may be introduced into the package, and then the package is sealed. The agent in the package may be absorbed into the device due to its capillary action. The amount the agent in the package can occupy 10%, 20%, 30%, 40%, 50%, 60%, 70%, 80%, 90%, 100% or over 100% of the void space in the porous dental care device.

In one embodiment, the sharp tip may be saturated with the agent/solution and the hand held region is not saturated with the agent/solution. The handheld region may be any region that is below the tip.

In another example, a device may be provided with a recessed area or a hollowed structure that is configured to hold a predetermined amount of gel, paste, powder, or other substance that is generally thicker or more viscous than liquid. The gel, paste, powder or substance may generally have the same properties as a typical toothpaste, tooth whitening gel, cuticle oil paste, alcohol paste, or any other cleaning agent. The material/agent may be provided in the recess or hollowed location 46, as illustrated by FIG. 13. The material/agent can vary from about 0.1 gram to about 1.0 gram. The amount of material/agent is designed to provide suitable cleaning action but to not require subsequent water rinsing (although subsequent rinsing is possible).

In one embodiment, material/agent may be injected or applied into the hollowed structure such that a continuous film of material is present throughout the structure. In another embodiment, only a portion of material is applied at the tip area and is not included in the entirety of the hollowed structure. For the dental device, this could allow the user to experience the taste and efficacy of the gel without providing so much gel that a water rinse is required.

Devices containing an agent can also be made on-site. The dry porous device could be dipped into a desired agent solution before the cleaning procedure. It should also be understood that the devices may be used without any additives or additional solutions for cleaning purposes described herein.

### Methods of Use

In use, the agent may be delivered to the targeted area. For example, the agent/solution may move from the device to the target area by capillary force. This process is similar to applying ink onto a paper with a writing instrument. The delivery may also be assisted by a squeezing action on the body of the device.

For the dental care device, the dental care solution inside the porous dental care device may be delivered to a targeted oral area by suction with the mouth. The oral cleaning agents inside the porous oral cleaning device may be delivered to a targeted oral area by rehydrating with saliva and scraping the target area. The dental care solution will move from the porous dental care device to the target area by the vacuum generated by suction on the porous dental care device. For example, the tip of porous dental care device may be placed on or near a targeted oral area. When the user closes his or her mouth and applies a suction force to the porous dental care device, the dental care solution inside the porous dental care device will be transferred from porous dental care device to the targeted oral area. The oral cleaning agents may move via being dissolved into the saliva and released from the porous oral cleaning device to the target area by capillary force. The delivery can be assisted by a squeezing action on the body of porous oral cleaning device. The intensity and duration of suction will determine the amount of dental care solution delivered to the targeted oral area.

The oral cleaning devices described herein can be used alone or used as tips or nibs with a holder. Holders may include an injected molded plastic tube. The holders may include an opening for receiving and supporting the device. The cleaning devices may be designed to be disposable devices.

The cleaning devices described may provide a simple way to conduct oral cleaning without the need for applying toothpaste or water. The cleaning devices may be self-supporting and strong enough to be used as a brush and handle. The pore structure of a porous oral cleaning device can make it possible to hold polishing liquid and provide a more efficient polishing effect, while not damaging soft tissues.

Embodiments of this disclosure also provide a method of conducting a manicure and/or a pedicure using the devices described. In one example, the device may have one or more nail cleaning and/or treatment substances incorporated therein. The incorporation may be via immersion, spraying, dipping, drying, formation with the core materials, entrapping the substance with the fibers or polymer precursors to form the device, or any other appropriate option. The device maybe provided as a dried device that can be re-hydrated or as a wet device.

For example, if a dehydrated (dried) device is provided, the device may be rehydrated with water or other organic solvents in order to release the impregnated nail treatment agents to the nail surface. If the device is provided as a pre-wetted device, it may be used directly. If the device is provided without any nail cleaning and/or treatment additive incorporated therein, it may be used directly on its own, or it may be dipped into a desired agent (such as a cuticle oil, an antibacterial agent, a nail polish remover, or other desired substance or any of the substances described herein).

In an alternate embodiment, the disposable self-supporting porous nail treatment device may be used as an applicator. The device may be dipped into a nail polish or polish remover fluid and saturated. The sharp tip of the device may be used to paint the nail edges and the flat section of the device may be used to paint a nail surface. The sharp tip of the device may easily provide sharp painted nail edges without over painting surrounding skin areas.

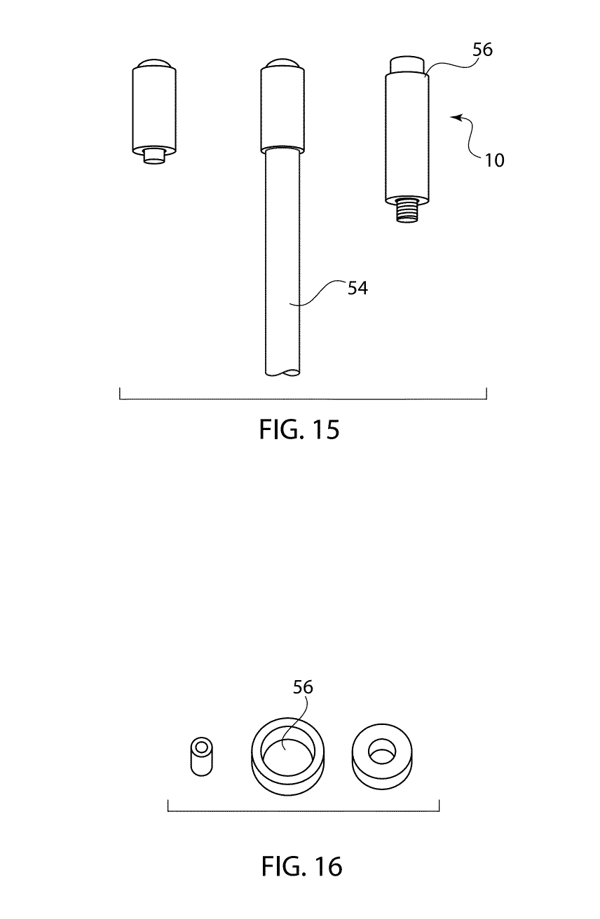

In other embodiments, the device 10 may be used for cleaning weaponry. As illustrated by FIG. 15, the device 10 may be positioned over a cleaning tool 54. As illustrated by FIG. 16, the device 10 may be provided with an opening 56 therethrough. In use, the opening 56 of the device 10 may be positioned over the cleaning tool 54.

The following examples will serve to further illustrate the present invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention.

### Example 1

### Porous Fiber Devices with Synthetic Biodegradable Bicomponent Fiber

A porous fiber product was made from pultrusion of synthetic poly(lactic acid) (PLA) or its copolymer concentric bicomponent fibers. In a specific embodiment, both core and sheath materials were PLA and the core PLA had a melting temperature higher than the melting temperature of sheath PLA (Far Eastern Textile Ltd. Ingeo SLN2450CM, 4 denier). It is preferred that the melting temperature difference is more than 10° C., more than 20° C. or more than 30° C. The melting temperature of the polymer can be controlled by manipulation of crystallization, the copolymerization or the blend as known to one of ordinary skill in the art of polymer chemistry.

The sliver was bonded together by using an oven pultrusion process. The synthetic biodegradable bicomponent fibers were composed of a concentric sheath and core material. To facilitate sintering, the PLA in the sheath material was of a lower melting point than the PLA in the core material. For this synthetic biodegradable bicomponent fiber, the melting point for the PLA sheath was about 132° C. and melting point for the PLA in the core was about 165° C. The oven temperature was controlled based on the manufacturing conditions. The temperature depended on the pultrusion speed and device diameter. The goal was to provide a sufficient amount of heat to the bicomponent fiber such that only the sheath of the bicomponent fiber melted but not the core. The silver was pultruded through an oven at a temperature of 204-221° C. and compressed through a die at a temperature of 49-66° C. The pultrusion speed was 2.0 to 4.0 inches/seconds. This process produced a cylindrical sintered porous matrix. A die compressed and shaped this matrix into rods that were subsequently air cooled and cut to length and at 60 degree angle.

### Example 2

### Porous Fiber Devices with Bicomponent Fiber and Naturally Colored Cotton Fiber

The porous device was made from combining sinterable polyethylene/polyester (PE/PET) concentric bicomponent fibers with non-sinterable, natural blue cotton fibers (Vreseis Ltd. Trade name: Fox fiber). These materials were blended in a 9:1 ratio and carded into sliver.

The sliver was bonded together using an oven pultrusion process. The bicomponent fibers were composed of a concentric sheath and core material. To facilitate sintering, the sheath material was of a lower melting point than the core material. The oven thermally bonded (melted) the sheath material of the bicomponent fibers to other bicomponent fibers and to the non-binding fibers. These non-binding fibers include monocomponent fibers such as naturally colored cotton or dyed cotton. The non-binding fibers generally do not melt and bind to each other. The silver was pultruded through an oven at a temperature of 175-220° C. and compressed through a die at a temperature of 49-66° C. The pultrusion speed was 2.0 to 4.0 inches/seconds. This process produced a cylindrical porous fiber device. A die compressed and shaped this matrix into rods that were subsequently air cooled and cut to length at a 15 to 75 degree angles.

### Example 3

### Porous Fiber Devices with Bicomponent Fiber and Dye Colored Cotton Fiber

A porous fiber device was made by combining sinterable polyethylene/polyester (PE/PET) bicomponent 3.0 Dtex (diameter)) (Trevira GMBH, Germany) and dye colored cotton fiber (50 mm long length Pima cotton, dyed by Littlewood Corp. using NovaChrome dyes manufactured by Huntsman (The Woodlands, Tex., US). The cotton was blue in color. These materials were blended in a 9:1 ratio and carded into sliver. The lower content dyed cotton fibers provided the color of the porous fiber dental care device.

The sliver was bonded together using an oven pultrusion process. The bicomponent fibers were composed of a concentric sheath and core material. To facilitate sintering, the sheath material had a lower melting point than the core material. The oven thermally bonded (melted) the sheath material of the bicomponent fibers to other bicomponent fibers and to the non-binding fibers. These non-binding fibers were dyed cotton fibers. The non-binding fibers generally do not melt and bind to each other. The silver was pultruded through an oven at a temperature of 175-220° C. and compressed through a die at a temperature of 49-66° C. The pultrusion speed was 2.0 to 4.0 inches/second. This process produced a cylindrical sintered porous matrix. A die compressed and shaped this matrix into rods that were subsequently air cooled and cut to length at 60 degree angle. The resulted porous fiber dental care device had the color of the dyed cotton.

### Example 4

### Porous Fiber Devices with Synthetic Bicomponent Fiber

A porous fiber device was made by binding synthetic concentric bicomponent fibers PE/PET bicomponent 3.0 Dtex (diameter)) (Trevira GMBH, Germany). The fibers were carded into sliver. The sliver was bonded together using an oven pultrusion process. The silver was pultruded through the oven at a temperature of 204-221° C. and compressed through a die at a temperature of 49-66° C. The pultrusion speed was 2.0 to 4.0 inches/seconds. This process produced a cylindrical sintered porous matrix. A die compressed and shaped this matrix into rods that were subsequently air cooled and cut to a desired length (which was 2 inches, but which could have been any length for any suitable purpose) and at a 60 degree angle.

### Example 5

### Porous Fiber Device with Impregnated Mouthwash Solution

The porous fiber devices made by any of the above examples is sprayed or soaked with Listerine mouthwash solution until the parts are saturated. The parts are packed into a hermetic sealable bag and sealed.

If dried before packaging, the devices may be dried in an oven at 80° C. under air circulation for about 1-2 hours. The porous fiber dental care device becomes dry and the chemical ingredients in the Listerine are impregnated into the porous matrix.

### Example 6

### Oral Cleaning Using a Dry Porous Fiber Oral Cleaning Device with Pre-Embedded Agent

A porous fiber dental care device with a hollowed structure was filled with 0.2 grams Aquafresh® toothpaste into the hollowed region. The porous fiber oral cleaning device was then used to clean the teeth by rubbing it against the tooth surface. The Aquafresh® toothpaste was transferred to the tooth surface and the device functioned as a toothbrush. Users reported feeling a fresh mouth. Because there is no foam forming during the brush process and because the amount of toothpaste is low, there is no need to rinse the mouth. It is believed that the toothpaste formed a thin protective layer on the teeth that can optionally be rinsed once reaching a suitable location.

In other examples, a porous fiber oral cleaning device may be made by applying 0.1 grams 3M ESPE 22% White & Brite Teeth Whitening Gel into the hollowed region in the porous fiber oral cleaning device. In another example, a porous oral fiber cleaning device was made by applying 0.1 grams Day White® ACP 7.5% Hydrogen Peroxide Bleaching Gel into the hollowed region in the porous fiber oral cleaning device. In a further example, a porous oral fiber cleaning device was made by immersing a porous fiber part into a 3% hydrogen peroxide solution for 10 minutes.

### Example 7

### Applying an Antifungal Agent Underneath the Fingernail, or on the Hyponychium, Cuticle and/or Eponychium Using a Dry Porous Fiber Manicure and Pedicure Device

A porous fiber manicure and pedicure device was made by cutting a 3 mm diameter porous fiber rod. The dry device was dipped into FUNGI NAIL® antifungal solution and used to apply the solution underneath a nail, on the hyponychium, cuticle and/or eponychium areas. The end of the device saturated with FUNGI NAIL® antifungal solution was inserted underneath the nail and the device's sharp and flat surface was used to massage underneath the nail, on the hyponychium, cuticle and/or eponychium surfaces. During the massage, most FUNGI NAIL® antifungal solution was transferred to the nail surface (whether underneath the nail, hyponychium, cuticle and eponychium areas). The process may be repeated to obtain optimal results. The device provided a pleasant process, because it did not hurt the sensitive hyponychium and helped the solution move into small cavities.

1. A porous cleaning device, comprising:
a self-supporting porous device body comprising porous fiber materials, sintered porous polymeric materials, elastomeric materials, or combinations thereof,
the porous device body comprising a working end and a holding section,
the working end configured to clean a desired surface and comprising a tip and a polishing surface.

2. The device of claim 1, wherein the porous device body comprises the same material throughout the body.

3. The device of claim 1, wherein the device body comprises porous fiber materials.

4. The device of claim 3, wherein the porous fiber materials comprise PE/PET, PET/PET biocomponent fibers, cotton fibers, or combinations thereof.

5. The device of claim 1, wherein the device is effective for removing food between teeth, scraping teeth, polishing teeth, massaging gums, or combinations thereof.

6. The device of claim 1, wherein the device is effective for polishing nails, cleaning nails, scraping nails, applying one or more agents to nails, or combination thereof.

7. The device of claim 1, wherein the device is effective for cleaning crevices or hard to reach places, applying a treatment agent to crevices or hard to reach places, or a combination thereof.

8. The device of claim 1, further comprising a cleaning or treatment agent.

9. The device of claim 8, wherein the cleaning or treatment agent comprises a dental care agent, a mouthwash solution, a breath freshener, a tooth whitener, an anti-microbial agent, an antimicrobial enhancing agent, a flavorant, a sweetener, a coloring agent, an anti-caries agent, a surfactant, a humectant, an anti-inflammatory agent, or any combination thereof.

10. The device of claim 8, wherein the cleaning or treatment agent comprises a nail care agent, an anti-fungal agent, an anti-microbial agent, antimicrobial enhancing agent, a coloring agent, a humectant, cuticle oil, nail polish remover, nail polish, or any combination thereof.

11. The device of claim 8, wherein the cleaning or treatment agent comprises alcohol, a disinfectant, bleach, ammonia, vinegar, wood cleaning oil, grout cleaner, grout sealant, spackle, paint, machine lubrication oil, gun oil, grease, a polisher gel, a silicon oil, an anti-bacterial wound treatment, an antibacterial cleaning agent, a surfactant or soap, or any combination thereof.

12. The device of claim 8, wherein the cleaning or treatment agent is impregnated into the device.

13. The device of claim 1, wherein the device comprises a hollowed structure for receiving a cleaning or treatment paste or gel.

14. A disposable porous cleaning device, comprising a single-piece, self-supporting porous structure impregnated with one or more treatment agents.

15. The device of claim 14, wherein the one or more treatment agents comprise dental treatment agents.

16. The device of claim 14, wherein the one or more treatment agents comprise nail treatment agents.

17. The device of claim 14, wherein the one or more treatment agents comprise cleaning agents or lubricants, or combinations thereof.

18. The device of claim 14, wherein the porous structure comprises a fibrous porous structure.

19. The device of claim 14, wherein the porous structure comprises a sintered porous polymeric structure.

20. The device of claim 14, wherein the porous structure comprises a sintered porous polymeric structure combined with one or more elastomers.

21. The device of claim 14, wherein the porous structure comprises a rod-shape with a hollow interior.

22. The device of claim 14, having a porosity from about 20% to about 90%.

23. The device of claim 14, wherein the structure is immersed in the one or more treatment agents.

24. The device of claim 14, wherein the one or more treatment agents are sprayed onto the structure.

25. A method for treating an oral cavity, comprising using the device of claim 15 for rubbing an oral surface and releasing the one or more dental treatment agents from the porous device to the oral surface.

26. A method for treating a nail surface, comprising using the device of claim 16 for cleaning one or more nail surfaces and releasing the one or more nail treatment agents from the porous device to the nail surface.

27. A method for treating a surface or applying a treatment agent, a cleaning agent, or a lubricant solution to a surface, comprising providing the device of claim 1 and using the device to clean the surface by using the tip and the polishing surface for treating the surface.

28. The method of claim 27, wherein the device is pre-impregnated or pre-loaded with the treatment agent, the cleaning agent, or the lubricant solution.

29. The method of claim 27, further comprising dipping the device into the treatment agent, the cleaning agent, or the lubricant solution.

30. A single piece self-supporting porous cleaning device comprising a hollowed structure for retaining a gel or paste cleaning substance.

31. The device of claim 1, wherein the device is effective as a liquid applicator.
